(19) United States
(12) Patent Application Publication
(10) Pub. No.: US 2024/0214735 A1
(43) Pub. Date: Jun. 27, 2024

(54) ELECTROMECHANICAL CONNECTORS

(71) Applicant: Cirrus Logic International Semiconductor Ltd., Edinburgh (GB)

(72) Inventors: Robert J. HATFIELD, Edinburgh (GB); Alastair M. BOOMER, Edinburgh (GB); John P. LESSO, Edinburgh (GB); Calum J. TAIT, Penicuik (GB)

(73) Assignee: Cirrus Logic International Semiconductor Ltd., Edinburgh (GB)

(21) Appl. No.: 18/529,364

(22) Filed: Dec. 5, 2023

Related U.S. Application Data
(60) Provisional application No. 63/434,547, filed on Dec. 22, 2022.
(60) Provisional application No. 63/434,608, filed on Dec. 22, 2022.

(30) Foreign Application Priority Data
Mar. 17, 2023 (GB) 2303953.0

(51) Int. Cl. H04R 5/04; H01R 24/58; H04R 1/10; H04R 3/12; H04R 29/00

(52) U.S. Cl. CPC H04R 5/04; H01R 24/58; H04R 1/1041; H04R 3/12; H04R 29/002; H04R 29/004; H04R 2420/03; H04R 2420/05; H04R 2420/09

(57) ABSTRACT

In an example there is provided circuitry for detecting a type of accessory connected to a first jack plug inserted into a first jack port. The circuitry is configured to determine whether an audio signal is present at the tip or the ring of the first jack plug. If there is an audio signal present at the tip or the ring of the first jack plug, then the circuitry is configured to determine that the type of accessory is a stereo line-in accessory connected to a 3-pole jack plug.

### TECHNICAL FIELD

The present disclosure relates to the identification and detection of devices that are connectable via electromechanical connectors.

### BACKGROUND

Electro-mechanical connectors are widely used for connecting accessories to devices that permit the transfer of signals between the accessory and the device. Audio jacks, for example, are used to connect audio devices, e.g. “accessory devices,” such as headphones, earphones, earbuds, and headsets etc., to other devices, e.g. “host devices,” such as personal computers (PCs), laptops, tablets, gaming devices, or mobile phones, and other mobile and/or portable devices etc.

Depending on the example therefore, an electromechanical connector may be used to connect an accessory device that outputs audio signals and/or receives input audio signals to a host device. It is therefore desirable for a host device to be able to interact with a wide range of accessory devices to enhance the user experience.

### STATEMENTS OF INVENTION

According to a first example there is provided circuitry for detecting a type of accessory connected to a first jack plug inserted into a first jack port, the circuitry being configured to: determine whether an audio signal is present at the tip or the ring of the first jack plug; and, if there is an audio signal present at the tip or the ring of the first jack plug, determine that the type of accessory is a stereo line-in accessory connected to a 3-pole jack plug.

The circuitry may be further configured to, if no audio signal is present at the tip or the ring of the first jack plug: enable a microphone bias to be applied to the tip and the ring of the first jack plug; and determine whether an audio signal is present at the tip or the ring of the first jack plug in response to the microphone bias; and, if there is an audio signal present in response to the microphone bias, determine that the type of accessory is a stereo microphone.

The circuitry may be further configured to, if there is no audio signal present in response to the microphone bias: determine that the type of accessory is a headphone and/or a line load.

The circuitry may be further configured to: disable the microphone bias; and to check whether the type of accessory is a stereo microphone, wherein, to perform the check, the circuitry is configured to: re-enable the microphone bias to the tip and the ring of the first jack plug; determining whether an audio signal is present at the tip or the ring of the first jack plug in response to the re-enabled microphone bias.

The circuitry may be further configured to, if there is an audio signal present at the tip or the ring of the first jack plug in response to the re-enabled microphone bias: confirm that the type of accessory is a stereo microphone. The circuitry is further configured to disable the re-enabled microphone bias.

The circuitry may be configured to, if there is no audio signal present in response to the re-enabled microphone bias: determine whether an audio signal is present at the tip or the ring of the first jack plug (which may represent the process returning to the beginning).

The circuitry may be further configured to, if no audio signal is present at the tip or the ring of the first jack plug: enable a microphone bias to the tip and the ring of the first jack plug; and determine whether an audio signal is present at the tip or the ring of the first jack plug in response to the microphone bias; and, if there is an audio signal present in response to the microphone bias: disable the microphone bias applied to the ring of the first jack plug determine whether audio input is present on the tip of the first jack plug; and, if there is audio input present on the tip of the first jack plug, determine that the type of accessory is a mono microphone connected to a 2-pole or to a 3-pole jack plug; and, if there is no audio input present on the tip of the first jack plug, determine that the type of accessory is a stereo microphone.

The circuitry may be further configured to: disable the microphone bias; and determine whether an audio signal is present at the tip or the ring of the first jack plug and, if there is an audio signal present: reclassify the type of accessory as a stereo line-in accessory.

The circuitry may be further configured to: disable the microphone bias; determine whether playback is enabled on an accessory connected to the first jack plug; compare the output of one or more digital-to-analogue converters with the output of one or more analogue-to-digital converters; determine whether the digital-to-analogue converter output matches the analogue-to-digital converter output; and, if the outputs do not match, reclassify the type of accessory as a stereo line in accessory.

The circuitry may be further configured to, if no audio signal is present at the tip or the ring of the first jack plug: enable an ultrasonic tone; and determine whether the ultrasonic signal is present at the tip or the ring of the first jack plug in response to the ultrasonic tone; and, if the ultrasonic signal is present at the tip or the ring of the first jack plug, determine that the type of accessory is a stereo microphone.

The circuitry may be further configured to, if no ultrasonic signal is present at the tip or the ring of the first jack plug in response to the ultrasonic tone: determine that the type of accessory is a headphone and/or a line load.

To enable the ultrasonic tone, the circuitry may be configured to: cause the ultrasonic tone to be output from one or more speakers and/or causing a transducer to transmit the ultrasonic tone.

The circuitry may be further configured to: determine a delay between the ultrasonic tone being received via the electrical path from the transducer and/or or speaker that output the ultrasonic tone and via an acoustic path between the transducer and/or speaker that output the ultrasonic tone and a transducer receiving the ultrasonic tone.

The circuitry may further comprise: a first jack plug detect module configured to detect whether the first jack plug is received in the first jack port.

The circuitry may comprise a first circuitry module comprising at least one of: left audio out circuitry; right audio out circuitry; impedance measurement circuitry; microphone biasing circuitry; microphone and ground switching circuitry; and microphone input circuitry.

The circuitry may comprise a second circuitry module comprising at least one of: a first stereo input circuitry; a second stereo input circuitry; impedance measurement circuitry; microphone biasing circuitry; and ground circuitry.

The circuitry may further comprise at least one of: a first source of voltage bias; a first headset bias line connected to the bias and connectable to the sleeve of a 4-pole jack plug; a second headset bias line connected to the bias and connectable to the second ring of a 4-pole jack plug or to the sleeve of a 3-pole jack plug; a first stereo line for left audio input connected to the bias and connectable to the tip of a 3-pole or a 4-pole jack plug; and a second stereo line for right audio input connected to the bias and connectable to the ring of a 3-pole jack plug or to the first ring of a 4-pole jack plug.

The circuitry may further comprise at least one of: a first digital to analogue converter; and a first headphone line for left headphone output connected to the first digital to analogue converter and connectable to the tip of a 3-pole or a 4-pole jack plug.

The circuitry may further comprise at least one of: a second digital to analogue converter; and a second headphone line for right headphone output connected to the second digital to analogue converter and connectable to the ring of a 3-pole jack plug or to the first ring of a 4-pole jack plug;

The circuitry may further comprise at least one of: a first analogue to digital converter; a first headset line connected to the first analogue to digital converter and connectable to the sleeve of a 4-pole jack plug; a second headset line connected to the first analogue to digital converter and connectable to the second ring of a 4-pole jack plug or to the sleeve of a 3-pole jack plug; a first stereo input line for right stereo audio connected to the first analogue to digital converter and connectable to the ring of a 3-pole jack plug or to the first ring of a 4-pole jack plug; and a first stereo input ground line connectable to the second ring of a 4-pole jack plug or to the sleeve of a 3-pole jack plug.

The circuitry may further comprise at least one of: a second analogue to digital converter; a second stereo input line for left stereo audio connected to the second analogue to digital converter and connectable to the tip of a 3-pole or 4-pole jack plug; and a second stereo input ground line connected to the second analogue to digital converter and connectable to the second ring of a 4-pole jack plug or to the sleeve of a 3-pole jack plug.

The circuitry may further comprise at least one of: a third digital to analogue converter configured to output an audio signal to a speaker.

According to another example there is provided a carrier (for example a printed circuit board, “PCB” or motherboard (e.g. a ceramic motherboard)) comprising the circuitry as described above. The carrier may comprise the first audio jack port. In another example, a device (e.g. a host device) may comprise the circuitry and/or the carrier as described above.

The circuitry may be further configured to detect a type of accessory connected to a second jack plug inserted into a second jack port, the circuitry being configured to: determine whether an audio signal is present at the tip or the ring of the second jack plug; and, if there is an audio signal present at the tip or the ring of the second jack plug, determine that the type of accessory is a stereo line-in accessory connected to a 3-pole jack plug.

The circuitry may be further configured to, if no audio signal is present at the tip or the ring of the second jack plug: enable a microphone bias to the tip and the ring of the second jack plug; and determine whether an audio signal is present at the tip or the ring of the second jack plug in response to the microphone bias; and, if there is an audio signal present in response to the microphone bias, determine that the type of accessory is a stereo microphone.

The circuitry may be further configured to, if there is no audio signal present in response to the microphone bias: determining that the type of accessory is a headphone and/or a line load.

The circuitry may be further configured to: disable the microphone bias; and to check whether the type of accessory is a stereo microphone, wherein, to perform the check, the circuitry is configured to: re-enable the microphone bias to the tip and the ring of the second jack plug; determining whether an audio signal is present at the tip or the ring of the second jack plug in response to the re-enabled microphone bias.

The circuitry may be further configured to, if there is an audio signal present at the tip or the ring of the second jack plug in response to the re-enabled microphone bias: confirm that the type of accessory is a stereo microphone. The circuitry may be further configured to: disable the re-enabled microphone bias.

The circuitry may be configured to, if there is no audio signal present at the tip or the ring of the second jack plug in response to the re-enabled microphone bias: determine whether an audio signal is present at the tip or the ring of the second jack plug.

The circuitry may be further configured to, if no audio signal is present at the tip or the ring of the second jack plug: enable a microphone bias to the tip and the ring of the second jack plug; and determine whether an audio signal is present at the tip or the ring of the second jack plug in response to the microphone bias; and, if there is an audio signal present in response to the microphone bias: disable the microphone bias applied to the ring of the second jack plug, determine whether audio input is present on the tip of the second jack plug; and, if there is audio input present on the tip of the second jack plug, determine that the type of accessory is a mono microphone connected to a 2-pole or to a 3-pole jack plug; and, if there is no audio input present on the tip of the second jack plug, determine that the type of accessory is a stereo microphone.

The circuitry may be further configured to: disable the microphone bias; and determine whether an audio signal is present at the tip or the ring of the second jack plug and, if there is an audio signal present: reclassify the type of accessory as a stereo line-in accessory.

The circuitry may be configured to: disable the microphone bias; determine whether playback is enabled on an accessory connected to the second jack plug; compare the output of one or more digital-to-analogue converters with the output of one or more analogue-to-digital converters; determine whether the digital-to-analogue converter output matches the analogue-to-digital converter output; and, if the outputs do not match, reclassify the type of accessory as a stereo line in accessory.

The circuitry may be further configured to, if no audio signal is present at the tip or the ring of the second jack plug: enable an ultrasonic tone; and determine whether the ultrasonic signal is present at the tip or the ring of the second jack plug in response to the ultrasonic tone and, if the ultrasonic signal is present at the tip or the ring of the second jack plug; determine that the type of accessory is a stereo microphone.

The circuitry may be further configured to, if no ultrasonic signal is present at the tip or the ring of the second jack plug in response to the ultrasonic tone: determine that the type of accessory is a headphone and/or a line load.

To enable the ultrasonic tone, the circuitry may be configured to: cause the ultrasonic tone to be output from one or more speakers and/or causing a transducer to transmit the ultrasonic tone.

The circuitry may be further configured to: determine a delay between the ultrasonic tone being received via the electrical path from the transducer and/or or speaker that output the ultrasonic tone and via an acoustic path between the transducer and/or speaker that output the ultrasonic tone and a transducer receiving the ultrasonic tone.

The circuitry may further comprise: a second jack plug detect module configured to detect whether the second jack plug is received in the first jack port.

The circuitry may further comprise a third circuitry module comprising at least one of: left audio out circuitry; right audio out circuitry; impedance measurement circuitry; microphone biasing circuitry; microphone and ground switching circuitry; and microphone input circuitry.

The circuitry may further comprise a fourth circuitry module comprising at least one of: a first stereo input circuitry; a second stereo input circuitry; impedance measurement circuitry; microphone biasing circuitry; and ground circuitry.

The circuitry may further comprise at least one of: a third source of voltage bias; a third headset bias line connected to the bias and connectable to the sleeve of a 4-pole jack plug; a fourth headset bias line connected to the bias and connectable to the second ring of a 4-pole jack plug or to the sleeve of a 3-pole jack plug; a third stereo line for left audio input connected to the bias and connectable to the tip of a 3-pole or a 4-pole jack plug; and a fourth stereo line for right audio input connected to the bias and connectable to the ring of a 3-pole jack plug or to the first ring of a 4-pole jack plug.

The circuitry may further comprise at least one of: a third digital to analogue converter; and a third headphone line for left headphone output connected to the third digital to analogue converter and connectable to the tip of a 3-pole or a 4-pole jack plug.

The circuitry may further comprise at least one of: a fourth digital to analogue converter; and a fourth headphone line for right headphone output connected to the fourth digital to analogue converter and connectable to the ring of a 3-pole jack plug or to the first ring of a 4-pole jack plug.

The circuitry may further comprise at least one of: a third analogue to digital converter; a third headset line connected to the third analogue to digital converter and connectable to the sleeve of a 4-pole jack plug; a fourth headset line connected to the third analogue to digital converter and connectable to the second ring of a 4-pole jack plug or to the sleeve of a 3-pole jack plug; a third stereo input line for right stereo audio connected to the third analogue to digital converter and connectable to the ring of a 3-pole jack plug or to the first ring of a 4-pole jack plug; and a third stereo input ground line connectable to the second ring of a 4-pole jack plug or to the sleeve of a 3-pole jack plug;

The circuitry may further comprise at least one of: a fourth analogue to digital converter; a fourth stereo input line for left stereo audio connected to the fourth analogue to digital converter and connectable to the tip of a 3-pole or 4-pole jack plug; and a fourth stereo input ground line connected to the fourth analogue to digital converter and connectable to the second ring of a 4-pole jack plug or to the sleeve of a 3-pole jack plug.

The circuitry may further comprise at least one of: a fifth digital to analogue converter configured to output an audio signal to a speaker.

The carrier may comprise a first conductive path configured to connect the circuitry to a first audio jack port and a second conductive path configured to connect the circuitry to a second audio jack port. The carrier may comprise the first and second jack ports. A device (e.g. a host device) may comprise the circuitry and/or the carrier as described above.

According to an example there is provided a carrier comprising a first conductive path and a second conductive path, wherein the first conductive path is configured to electrically connect circuitry with a first jack port, and wherein the second conductive path is configured to electrically connect the circuitry with a second jack port.

The carrier may comprise a first module configured to detect the insertion of a first audio jack in the first jack port and a second module configured to detect the insertion of a second jack plug in the second jack port, wherein the first conductive path is configured to electrically connect the first module with the first jack port, and wherein the second conductive path is configured to electrically connect the second module with the second jack port.

The carrier may comprise tip detect circuitry and ring detect circuitry, wherein the first conductive path is configured to electrically connect the tip detect circuitry with the first jack port and wherein the second conductive path is configured to electrically connect the ring detect circuitry with the second jack port.

The tip detect circuitry may be configured to detect the full insertion of the first audio jack plug in the first jack port and wherein the ring detect circuitry may be configured to detect the full insertion of the second audio jack plug in the second jack port.

The carrier may comprise first tip detect circuitry and second tip detect circuitry, wherein the first conductive path is configured to electrically connect the first tip detect circuitry with the first jack port and wherein the second conductive path is configured to electrically connect the second tip detect circuitry with the second jack port.

The first tip detect circuitry may be configured to detect the full insertion of the first audio jack plug in the first jack port and wherein the second tip detect circuitry may be configured to detect the full insertion of the second audio jack plug in the second jack port.

The carrier may comprise the first and second audio jack ports. The carrier may comprise the circuitry as described above.

Specifically, the carrier may comprise circuitry configured to detect a type of accessory connected to the first jack plug inserted into the first jack port, the circuitry being configured to: determine whether an audio signal is present at the tip or the ring of the first jack plug; and, if there is an audio signal present at the tip or the ring of the first jack plug, determine that the type of accessory is a stereo line-in accessory.

The circuitry may be further configured to, if no audio signal is present at the tip or the ring of the first jack plug: enable a microphone bias to be applied to the tip and the ring of the first jack plug; and determine whether an audio signal is present at the tip or the ring of the first jack plug in response to the microphone bias; and, if there is an audio signal present in response to the microphone bias, determine that the type of accessory is a stereo microphone.

The circuitry may be further configured to, if there is no audio signal present in response to the microphone bias: determining that the type of accessory is a headphone and/or a line load.

The circuitry may be further configured to: disable the microphone bias and to check whether the type of accessory is a stereo microphone, wherein, to perform the check, the circuitry is configured to: re-enable the microphone bias to the tip and the ring of the first jack plug; determining whether an audio signal is present at the tip or the ring of the first jack plug in response to the re-enabled microphone bias.

The circuitry may be further configured to, if there is an audio signal present at the tip or the ring of the first jack plug in response to the re-enabled microphone bias: confirm that the type of accessory is a stereo microphone. The circuitry may be further configured to: disable the re-enabled microphone bias.

The circuitry may be configured to, if there is no audio signal present in response to the re-enabled microphone bias: determine whether an audio signal is present at the tip or the ring of the first jack plug.

The circuitry may be further configured to, if no audio signal is present at the tip or the ring of the first jack plug: enable a microphone bias to the tip and the ring of the first jack plug; and determine whether an audio signal is present at the tip or the ring of the first jack plug in response to the microphone bias; and, if there is an audio signal present in response to the microphone bias: disable the microphone bias applied to the ring of the first jack plug; determine whether audio input is present on the tip of the first jack plug; and, if there is audio input present on the tip of the first jack plug, determine that the type of accessory is a mono microphone connected to a 2-pole or to a 3-pole jack plug; and, if there is no audio input present on the tip of the first jack plug, determine that the type of accessory is a stereo microphone.

The circuitry may be further configured to: disable the microphone bias; and determine whether an audio signal is present at the tip or the ring of the first jack plug and, if there is an audio signal present: reclassify the type of accessory as a stereo line-in accessory.

The circuitry is configured to: disable the microphone bias; determine whether playback is enabled on an accessory connected to the first jack plug; compare the output of one or more digital-to-analogue converters with the output of one or more analogue-to-digital converters; determine whether the digital-to-analogue converter output matches the analogue-to-digital converter output; and, if the outputs do not match, reclassify the type of accessory as a stereo line in accessory.

The circuitry may be further configured to, if no audio signal is present at the tip or the ring of the first jack plug: enable an ultrasonic tone; and determine whether the ultrasonic signal is present at the tip or the ring of the first jack plug in response to the ultrasonic tone and, if the ultrasonic signal is present at the tip or the ring of the first jack plug; determine that the type of accessory is a stereo microphone.

The circuitry may be further configured to, if no ultrasonic signal is present at the tip or the ring of the first jack plug in response to the ultrasonic tone: determine that the type of accessory is a headphone and/or a line load.

To enable the ultrasonic tone, the circuitry may be configured to: cause the ultrasonic tone to be output from one or more speakers and/or causing a transducer to transmit the ultrasonic tone.

The circuitry may be further configured to: determine a delay between the ultrasonic tone being received via the electrical path from the transducer and/or or speaker that output the ultrasonic tone and via an acoustic path between the transducer and/or speaker that output the ultrasonic tone and a transducer receiving the ultrasonic tone.

The circuitry may further comprise: a first jack plug detect module configured to detect whether the first jack plug is received in the first jack port.

The circuitry may further comprise a first circuitry module comprising at least one of: left audio out circuitry; right audio out circuitry; impedance measurement circuitry; microphone biasing circuitry; microphone and ground switching circuitry; and microphone input circuitry.

The circuitry may comprises a second circuitry module comprising at least one of: a first stereo input circuitry; a second stereo input circuitry; impedance measurement circuitry; microphone biasing circuitry; and ground circuitry.

The circuitry may comprises at least one of: a first source of voltage bias; a first headset bias line connected to the bias and connectable to the sleeve of a 4-pole jack plug; a second headset bias line connected to the bias and connectable to the second ring of a 4-pole jack plug or to the sleeve of a 3-pole jack plug; a first stereo left line connected to the bias and connectable to the tip of a 3-pole or a 4-pole jack plug; and a second stereo right line connected to the bias and connectable to the ring of a 3-pole jack plug or to the first ring of a 4-pole jack plug.

The circuitry may comprises at least one of: a first digital to analogue converter; and a first left headphone output line connected to the first digital to analogue converter and connectable to the tip of a 3-pole or a 4-pole jack plug;

The circuitry may comprise at least one of: a second digital to analogue converter; and a first right headphone output line connected to the second digital to analogue converter and connectable to the ring of a 3-pole jack plug or to the first ring of a 4-pole jack plug.

The circuitry may comprise at least one of: a first analogue to digital converter; a first headset line connected to the first analogue to digital converter and connectable to the sleeve of a 4-pole jack plug; a second headset line connected to the first analogue to digital converter and connectable to the second ring of a 4-pole jack plug or to the sleeve of a 3-pole jack plug; a first right stereo input line connected to the first analogue to digital converter and connectable to the ring of a 3-pole jack plug or to the first ring of a 4-pole jack plug; and a first stereo input ground line connectable to the second ring of a 4-pole jack plug or to the sleeve of a 3-pole jack plug.

The circuitry may comprises at least one of: a second analogue to digital converter; a first left stereo input line connected to the second analogue to digital converter and connectable to the tip of a 3-pole or 4-pole jack plug; and a second stereo input ground line connected to the second analogue to digital converter and connectable to the second ring of a 4-pole jack plug or to the sleeve of a 3-pole jack plug.

The circuitry comprises at least one of: a third digital to analogue converter configured to output an audio signal to a speaker.

The circuitry may be further configured to detect a type of accessory connected to the second jack plug inserted into the second jack port, the integrated circuit being configured to: determine whether an audio signal is present at the tip or the ring of the second jack plug; and, if there is an audio signal present at the tip or the ring of the second jack plug, determine that the type of accessory is a stereo line-in accessory and that the second jack plug is a 3-pole jack plug.

The circuitry may be further configured to, if no audio signal is present at the tip or the ring of the second jack plug: enable a microphone bias to the tip and the ring of the second jack plug; and determine whether an audio signal is present at the tip or the ring of the second jack plug in response to the microphone bias; and, if there is an audio signal present in response to the microphone bias, determine that the type of accessory is a stereo microphone and that the second jack plug is a 3-pole jack plug.

The circuitry may be further configured to, if there is no audio signal present in response to the microphone bias: determining that the type of accessory is a headphone and/or a line load and that the second jack plug is a 3-pole jack plug.

The circuitry may be further configured to: disable the microphone bias; and to check whether the type of accessory is a stereo microphone, wherein, to perform the check, the circuitry is configured to: re-enable the subsequent microphone bias to the tip and the ring of the second jack plug; determining whether an audio signal is present at the tip or the ring of the second jack plug in response to the re-enabled microphone bias.

The circuitry may be further configured to, if there is an audio signal present at the tip or the ring of the second jack plug in response to the re-enabled microphone bias: confirm that the type of accessory is a stereo microphone. The circuitry may be further configured to: disable the subsequent microphone bias.

The circuitry may be configured to, if there is no audio signal present at the tip or the ring of the second jack plug in response to the re-enabled microphone bias: determine whether an audio signal is present at the tip or the ring of the second jack plug.

The circuitry may be further configured to, if no audio signal is present at the tip or the ring of the second jack plug: enable a microphone bias to the tip and the ring of the second jack plug; and determine whether an audio signal is present at the tip or the ring of the second jack plug in response to the microphone bias; and, if there is an audio signal present in response to the microphone bias: disable the microphone bias applied to the ring of the second jack plug, determine whether audio input is present on the tip of the second jack plug; and, if there is audio input present on the tip of the second jack plug, determine that the type of accessory is a mono microphone connected to a 2-pole or to a 3-pole jack plug; and, if there is no audio input present on the tip of the second jack plug, determine that the type of accessory is a stereo microphone.

The circuitry may be further configured to: disable the microphone bias; and determine whether an audio signal is present at the tip or the ring of the second jack plug and, if there is an audio signal present: reclassify the type of accessory as a stereo line-in accessory.

The circuitry may be configured to: disable the microphone bias; determine whether playback is enabled on an accessory connected to the second jack plug; compare the output of one or more digital-to-analogue converters with the output of one or more analogue-to-digital converters; determine whether the digital-to-analogue converter output matches the analogue-to-digital converter output; and, if the outputs do not match, reclassify the type of accessory as a stereo line in accessory.

The circuitry may be further configured to, if no audio signal is present at the tip or the ring of the second jack plug: enable an ultrasonic tone; and determine whether the ultrasonic signal is present at the tip or the ring of the second jack plug in response to the ultrasonic tone and, if the ultrasonic signal is present at the tip or the ring of the second jack plug; determine that the type of accessory is a stereo microphone and that the second jack plug is a 3-pole jack plug.

The may be is further configured to, if no ultrasonic signal is present at the tip or the ring of the second jack plug in response to the ultrasonic tone: determine that the type of accessory is a headphone and/or a line load.

To enable the ultrasonic tone, the circuitry may be configured to: cause the ultrasonic tone to be output from one or more speakers and/or causing a transducer to transmit the ultrasonic tone.

The circuitry may be further configured to: determine a delay between the ultrasonic tone being received via the electrical path from the transducer and/or or speaker that output the ultrasonic tone and via an acoustic path between the transducer and/or speaker that output the ultrasonic tone and a transducer receiving the ultrasonic tone.

The circuitry may comprise: a second jack plug detect module configured to detect whether the second jack plug is received in the first jack port.

The circuitry may comprise a third circuitry module comprising at least one of: left audio out circuitry; right audio out circuitry; impedance measurement circuitry; microphone biasing circuitry; microphone and ground switching circuitry; and microphone input circuitry.

The circuitry comprises a fourth circuitry module comprising at least one of: a first stereo input circuitry; a second stereo input circuitry; impedance measurement circuitry; microphone biasing circuitry; and ground circuitry.

The circuitry may further comprises at least one of: a third source of voltage bias; a third headset bias line connected to the bias and connectable to the sleeve of a 4-pole jack plug; a fourth headset bias line connected to the bias and connectable to the second ring of a 4-pole jack plug or to the sleeve of a 3-pole jack plug; a third stereo left line connected to the bias and connectable to the tip of a 3-pole or a 4-pole jack plug; and a fourth stereo right line connected to the bias and connectable to the ring of a 3-pole jack plug or to the first ring of a 4-pole jack plug.

The circuitry may further comprise at least one of: a third digital to analogue converter; and a third left headphone output line connected to the third digital to analogue converter and connectable to the tip of a 3-pole or a 4-pole jack plug.

The circuitry further comprises at least one of: a fourth digital to analogue converter; and a third right headphone output line connected to the fourth digital to analogue converter and connectable to the ring of a 3-pole jack plug or to the first ring of a 4-pole jack plug.

The circuitry further comprises at least one of: a third analogue to digital converter; a third headset line connected to the third analogue to digital converter and connectable to the sleeve of a 4-pole jack plug; a fourth headset line connected to the third analogue to digital converter and connectable to the second ring of a 4-pole jack plug or to the sleeve of a 3-pole jack plug; a third right stereo input line connected to the third analogue to digital converter and connectable to the ring of a 3-pole jack plug or to the first ring of a 4-pole jack plug; and a third stereo input ground line connectable to the second ring of a 4-pole jack plug or to the sleeve of a 3-pole jack plug.

The circuitry may further comprise at least one of: a fourth analogue to digital converter; a third left stereo input line connected to the fourth analogue to digital converter and connectable to the tip of a 3-pole or 4-pole jack plug; and a fourth stereo input ground line connected to the fourth analogue to digital converter and connectable to the second ring of a 4-pole jack plug or to the sleeve of a 3-pole jack plug.

The circuitry may further comprise at least one of: a fifth digital to analogue converter configured to output an audio signal to a speaker.

A device may comprise the carrier as described above.

According to this disclosure there is therefore provided a process (or method), the method being implementable by circuitry (e.g. in a host device and/or mounted to a carrier etc.). The method is for detecting a type of accessory connected to a jack plug inserted into a jack port, and comprises: determining whether an audio signal is present at the tip or the ring of the jack plug; and, if there is an audio signal present, determining that the type of accessory is a stereo line-in accessory connected to a 3-pole jack plug.

If no audio signal is present then the method may comprise: enabling a microphone bias on the tip and the ring of the jack plug; and determining whether an audio signal is present at the tip or the ring in response to the microphone bias; and, if there is an audio signal present in response to the microphone bias, determining that the type of accessory is a stereo microphone.

If there is no audio signal present in response to the microphone bias then the method may comprise: determining that the type of accessory is a headphone and/or a line load.

The method may comprise: disabling the microphone bias; and reenabling the microphone bias; determining whether an audio signal is present at the tip or the ring in response to the subsequent microphone bias.

If there is an audio signal present in response to the re-enabled microphone bias then the method may comprise: confirming that the type of accessory is a stereo microphone. The method may comprise: disabling the re-enabled microphone bias.

If there is no audio signal present in response to the re-enabled microphone bias the method may comprise: determining whether an audio signal is present at the tip or the ring of the jack plug.

If there is no audio signal present at the tip or the ring of the first jack plug the method may comprise: enabling a microphone bias to the tip and the ring of the first jack plug; determining whether an audio signal is present at the tip or the ring of the first jack plug in response to the microphone bias; and, if there is an audio signal present in response to the microphone bias: disabling the microphone bias applied to the ring of the first jack plug, determining whether audio input is present on the tip of the first jack plug; and, if there is audio input present on the tip of the first jack plug, determining that the type of accessory is a mono microphone connected to a 2-pole or to a 3-pole jack plug; and, if there is no audio input present on the tip of the first jack plug, determining that the type of accessory is a stereo microphone.

The method may further comprise: disabling the microphone bias; and determining whether an audio signal is present at the tip or the ring of the jack plug; and, if there is an audio signal present: reclassifying the type of accessory as a stereo line-in accessory.

The method may comprise: disabling the microphone bias; determining whether playback is enabled on an accessory connected to the first jack plug; comparing the output of one or more digital-to-analogue converters with the output of one or more analogue-to-digital converters; determining whether the digital-to-analogue converter output matches the analogue-to-digital converter output; and, if the outputs do not match, reclassifying the type of accessory as a stereo line in accessory.

If no audio signal is present the method may comprise: enabling an ultrasonic tone; and determining whether the ultrasonic signal is present at the tip or the ring in response to the ultrasonic tone; and, if the ultrasonic signal is present at the tip or the ring, determining that the type of accessory is a stereo microphone.

If no ultrasonic signal is present at the tip or the ring in response to the ultrasonic tone the method may comprise: determining that the type of accessory is a headphone and/or a line load.

The method may comprise: disabling the ultrasonic tone; and determining whether an audio signal is present at the tip or the ring of the jack plug; and, if there is no audio signal present. If there is an audio signal present the method may comprise: reclassifying the type of accessory as a stereo line-in accessory.

Enabling an ultrasonic tone may comprise: causing the ultrasonic tone to be output from one or more speakers and/or causing a transducer to transmit the ultrasonic tone.

The method may comprise: determining a delay between the ultrasonic tone being received via the electrical path from the transducer and/or or speaker that output the ultrasonic tone and via an acoustic path between the transducer and/or speaker that output the ultrasonic tone and a transducer receiving the ultrasonic tone.

An example method may comprise: determining whether a jack plug inserted into a jack port is a 4-pole jack plug; and, in response to determining that the jack plug is not a 4-pole jack plug; performing the method as described above. The method may comprise: determining whether a first jack plug inserted into a first jack port is a 4-pole jack plug; and, in response to determining that the first jack plug is not a 4-pole jack plug; performing the method as described above. Alternatively or additionally, the method may comprise: determining whether a second jack plug inserted into a second jack port is a 4-pole jack plug; and, in response to determining that the second jack plug is not a 4-pole jack plug; performing the method as described above.

An example method may comprise: determining whether a jack plug is received in a jack port; and, upon determining that the jack plug is received in the jack port, performing the method as described above. The method may comprise: determining whether a first jack plug is received in a first jack port; and, upon determining that the first jack plug is received in the first jack port, performing the method as described above. Alternatively, or additionally, the method comprise: determining whether a second jack plug is received in a second jack port; and, upon determining that the second jack plug is received in the second jack port, performing the method as described above.

As stated above, examples of this disclosure provide circuitry configured to perform the methods described above. The circuitry may therefore be configured to perform this method to detect a type of accessory connected to a first jack plug inserted into a first jack port and to detect a type of accessory connected to a second jack plug inserted into a second jack port.

According to an example of this disclosure there is provided circuitry coupled to a socket for receiving a plug that is coupled to an accessory, the circuitry comprising:
plug insertion detect circuitry;
stereo accessory detect circuitry; and
non-stereo accessory detect circuitry.

According to an example of this disclosure there is provided a socket for receiving a plug that is coupled to an accessory, the socket being coupled to circuitry comprising:
plug insertion detect circuitry;
stereo accessory detect circuitry; and
non-stereo accessory detect circuitry.

According to an example of this disclosure there is provided a plurality of sockets each for receiving a respective plug that is coupled to an accessory, each of the plurality of sockets being coupled to circuitry comprising:
plug insertion detect circuitry;
stereo accessory detect circuitry; and
non-stereo accessory detect circuitry.

According to an example there is provided a device (e.g. a host device) comprising the circuitry as described above (e.g. plug insertion detect circuitry; stereo accessory detect circuitry; and non-stereo accessory detect circuitry) and/or comprising a socket, or a plurality of sockets, coupled to the circuitry.

According to another example there is provided a host device comprising at least two sockets. In an example a first socket is a dedicated stereo accessory socket and a second socket is a dedicated non-stereo accessory socket. These may be part of a device (e.g. a host device).

A device, or host device, herein may comprise any one or more of personal computer, laptop, tablet, gaming device, communications device, mobile phone, a portable device and/or a battery powered device.

### DESCRIPTION OF THE DRAWINGS

FIGS. 1 and 2 respectively schematically indicate 4-pole and 3-pole jack plugs;

FIG. 3 schematically indicates two types of 4-pole jack plugs and two types of 3-pole jack plugs;

FIG. 4a schematically indicates two types of 3-pole jack plugs and FIG. 4b schematically indicates their impedances;

FIGS. 5a-5c and 6 schematically indicate processes according to examples of this disclosure;

FIGS. 7a and 7b (which may collectively be referred to herein as FIG. 7) schematically indicate processes according to examples of this disclosure;

FIGS. 8 and 9a-9c schematically indicate circuitry for performing the processes of this disclosure;

FIGS. 10a-10d schematically indicate circuitry according to examples of this disclosure being used as part of a host device;

FIG. 11a schematically indicates circuitry according to examples of this disclosure being used as part of a host device;

FIG. 11b schematically indicates a carrier structure according to an example of this disclosure;

FIG. 11c schematically illustrates according to examples of this disclosure in combination with two jack ports;

FIG. 11d schematically indicates a carrier structure according to an example of this disclosure;

FIG. 12 schematically indicates a process according to an example of this disclosure;

FIG. 13 schematically indicates circuitry for performing the processes of this disclosure; and

FIG. 14 schematically indicates 3-pole and 2-pole jack ports connected to mono accessory devices.

### DETAILED DESCRIPTION

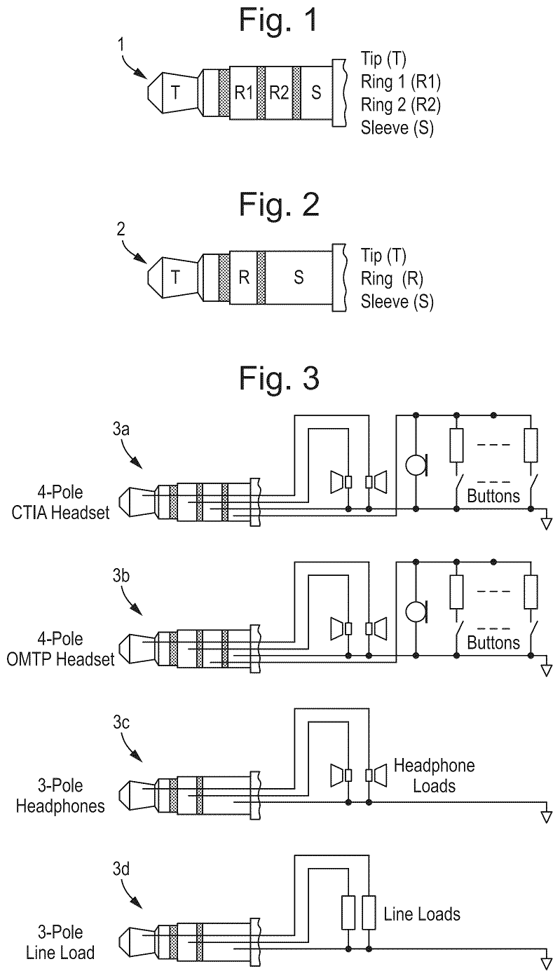

FIGS. 1 and 2 illustrate two types of electromechanical connectors, each depicted as an audio jack plug. FIG. 1 depicts a 4-pole jack plug 1 having four electrical contacts (or conductors or poles): a tip T, a first ring R1, a second ring R2, and a sleeve S. FIG. 2 depicts a 3-pole jack plug 2 having three electrical contacts (or conductors or poles): a tip T, a ring R, and a sleeve S. Due to the presence of the tip and sleeve contacts, and the number of rings, the FIG. 1 jack plug 1 may be referred to as a “TRRS” jack plug; the FIG. 2 jack plug 2 may be referred to as a “TRS” jack plug.

In an example, the TRRS jack plug 1 may be utilised for connecting an accessory device, having both a speaker and a microphone, to a host device, since the four pole structure of the TRRS jack plug 1 can enable both output audio (e.g. audio output to a speaker of the accessory device) and input audio (e.g. received by a microphone of the accessory device) to be transmitted both from/to the host device. For example, the tip T of the TRRS plug 1 can carry a left audio channel signal (e.g. to a left speaker of an accessory device connected to the TRRS plug 1), the first ring R1 can carry a right audio channel signal (e.g. to a right speaker of the accessory device), and the second ring R2 and the sleeve S can each carry either a microphone input audio signal (e.g. from a microphone of the accessory device), or provide a ground connection. Thus, the TRRS jack plug 1 may be utilised for accessory devices supporting stereo audio and having a microphone.

In an example, the TRS jack plug 2 may be utilised for connecting an accessory device, having a speaker, to a host device. For example, the tip T of the TRS plug 2 can carry a left audio channel signal (e.g. to a left speaker of an accessory device connected to the TRS plug 2), the ring R can carry a right audio channel signal (e.g. to a right speaker of the accessory device), and the sleeve S provides a ground connection. Thus, the TRS jack plug 2 may be utilised for accessory devices supporting stereo audio.

FIG. 3 schematically illustrates four examples of accessory types that may be used with host electronic devices, the types of jack plug to which they are connected, and how they utilise tip/ring(s)/sleeve structure.

At 3a there is indicated how an accessory comprising a microphone and headset may be connected to a 4-pole jack plug according to the Cellular Telecommunications and Internet Association (“CTIA”) standard/configuration. According to this configuration, the left and right speakers of the headset are connected to the tip T and ring1 R1 of the 4-pole jack plug, respectively, with ring2 R2 being a ground connection and the sleeve S being connected to a microphone of the headset.

At 3b there is indicated how an accessory comprising a microphone and headset may be connected to a 4-pole jack plug according to the Open Mobile Terminal Platform (“OMTP”) standard. According to this configuration, the left and right speakers of the headset are connected to the tip T and ring1 R1 of the 4-pole jack plug, respectively, with ring2 R2 being connected to a microphone of the headset and the sleeve S being a ground connection.

At 3c there is indicated how a stereo headphone accessory comprising headphone (“HP”) loads (e.g. left and right headphone speakers) may be connected to a 3-pole jack plug, where the left speaker is connected to the tip T and the right speaker is connected to the ring R, and the sleeve S is a ground connection.

At 3d there is indicated how a stereo line load (“LL”) accessory (e.g. an accessory comprising two line loads) may be connected to a 3-pole jack plug, where the left line load is connected to the tip T, the right line load is connected to the ring R, and the sleeve S is a ground connection.

A host device comprises a port configured to receive a jack plug may not know in advance what type of accessory it is going to receive (and therefore what kind of ‘connector structure’ the accessory and jack plug have). A user could manually select what kind of accessory is connected to the device but their selection could be wrong and, in any case, it is time consuming and bothersome for the user to make the selection themselves.

The present disclosure provides circuitry configured to determine a type of stereo accessory that is configured to drive stereo audio into and/or out of a host device through an electromechanical connection between a jack plug to which it is connected and a corresponding jack port (also known as a “socket”) of the host device. In this way, the host device can support stereo input/output signals from/to stereo transducers connected via a jack plug. Such stereo input/output accessories may include a stereo microphone (“SMIC”), e.g. a passive stereo microphone, a stereo line input device (“SLI”), and a stereo line output device (“SLO”).

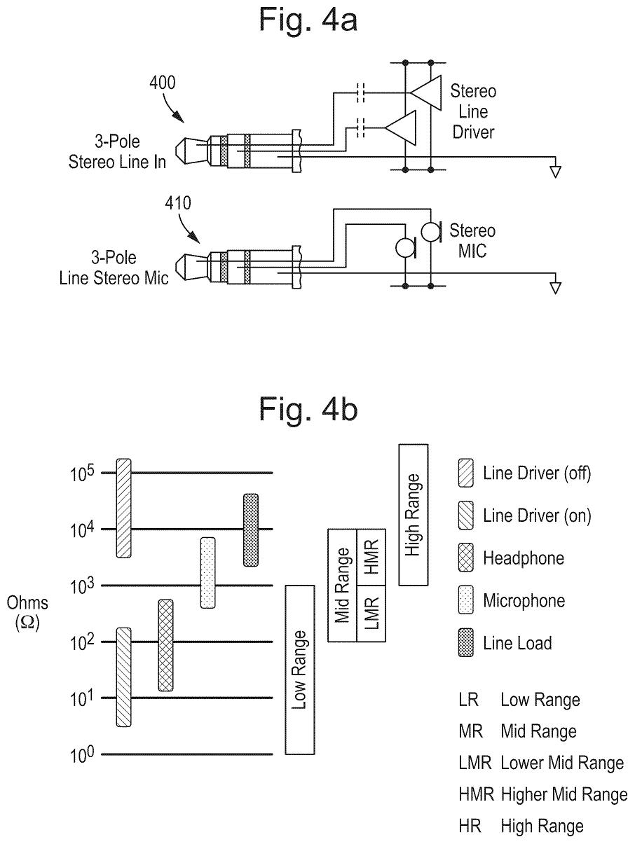

FIG. 4a illustrates, at 400, how a SLI accessory device may be connected to a 3-pole jack plug and, at 410, how a SMIC accessory device may be connected to a 3-pole jack plug. At 400 it is shown that the left and right stereo drivers are connected to the tip T and ring R of the 3-pole jack plug. At 410 it is shown that the left and right audio input microphone lines are connected to the tip T and ring R of the 3-pole jack plug. In both examples, the sleeve S is a ground connection.

Load impedances can sometimes determine the type of accessory device but FIG. 4b shows that the typical impedance ranges for the types of accessory devices illustrated in in FIG. 4a may overlap (and can vary depending on the state of the load; a line driver for example may have a different impedance depending on whether the line driver is ‘on’ or ‘off). Therefore, using impedance values alone may not lead to the reliable detection of an accessory device of the type shown in FIG. 4a.

According to this disclosure there is provided circuitry to automatically detect a stereo accessory type, such as the SLI 4a or SMIC 4b (or indeed a non-stereo accessory including a headphone (HP), line-in (LI), or line-out (LO) accessory). The circuitry according to this disclosure can detect these accessory types in addition to being able to detect accessories such as a CTIA/OMTP headset and HP and LL accessory types 3a-d depicted in FIG. 3.

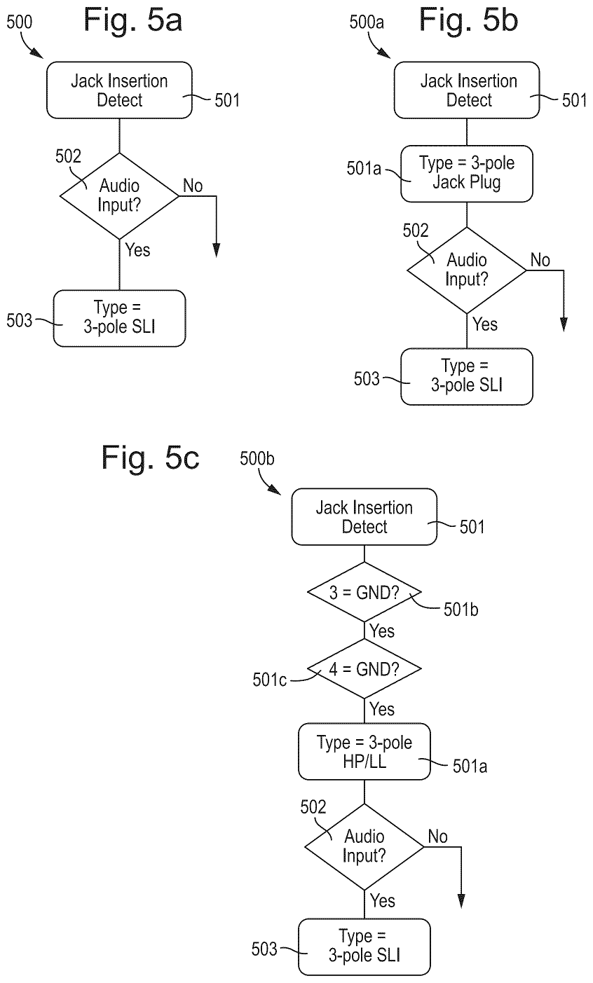

FIG. 5a shows a flowchart of a process 500 configured to be performed by circuitry to detect a type of accessory connected to a first jack plug inserted into a first jack port using “jack detect”, or “sense circuitry”. At 501, the process comprises detecting whether a first jack plug has been inserted into a first jack port. At 502 the process comprises determining whether an audio signal is present, or detected, at the tip T or the ring R of the first jack plug. For example, step 502 may comprise determining whether an audio signal is detected at analogue-to-digital converters (“ADCs”) that are respectively connected to the tip and the ring R of the jack port (this will be described later). If such an audio signal is present, then at 503 the process comprises identifying the type of accessory as an SLI accessory.

This process recognises that while operating normally, devices comprising line inputs and active microphones generate audio signals which may be detectable such as via ADCs. Therefore, the presence of an audio signal on the tip T or ring R may be used to distinguish between the stereo accessory types 400 and 410 with “passive loads” (which may not normally generate audio signals). Active loads (such as active stereo microphones for example) have their own power supply and do not require a microphone bias (“MBias”) voltage to generate audio, and such types of active loads may appear to a host device as SLI type loads. In other words, the detection of an audio signal at the tip T or ring R of the jack plug may provide a reliable indication that a SLI or SMIC device is present.

FIG. 5b shows a process 500a which comprises an optional step, 501a, in the process of FIG. 5a. According to FIG. 5b, after the insertion of the first jack plug in the corresponding first jack port is detected, the process comprises, at 501a, determining whether the type of jack plug is a 3-pole jack plug. The process then proceeds to determine whether there is audio input present at the tip T or the ring R of the 3-pole jack plug etc. as described above.

FIG. 5c shows a process 500b illustrating, at 501b-c, one example way of determining that the first jack plug is a 3-pole jack plug. At 501b the process comprises determining whether a contact in the first jack port corresponding to the sleeve S of a 3-pole jack plug or Ring2 R2 of a 4-pole jack plug is grounded. If this contact is grounded, at 501c, the process comprises determining whether a contact corresponding to the sleeve S of a 4-pole jack plug is grounded. If this contact is also grounded then the process may determine that the jack plug is a 3-pole jack plug (for example a headphone (HP) or line-load (LL) 3-pole jack plug), as at 501a above.

It will be understood that the present disclosure provides circuitry configured to perform the processes described herein, and that the circuitry is configured to determine whether (for example) a signal (e.g. audio or ground) is present at an electrical contact in a jack port (or socket), e.g. of a host device (e.g. comprising the circuitry) corresponding to the tip/ring/rings/sleeve etc.

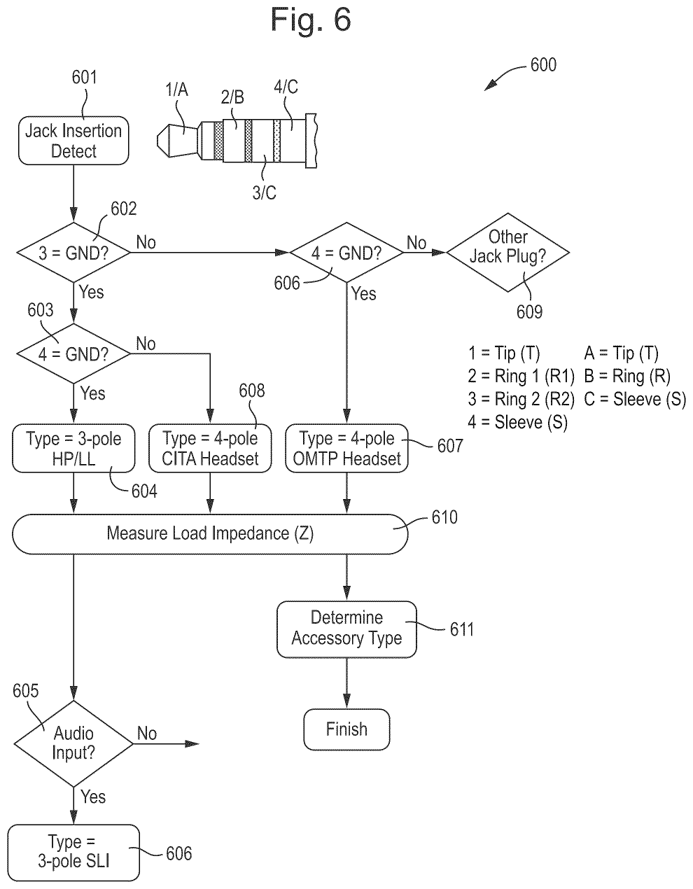

FIG. 6 illustrates a flow chart of a process 600 which may comprise any of the processes as described above. According to the process of FIG. 6, the circuitry is configured to also determine whether a first jack plug, inserted in a corresponding first jack port, is a 4-pole jack plug and, if so, the type of 4-pole jack plug. Upon determining that the jack plug is not a 4-pole jack plug the process may be as described above for FIGS. 5-5b.

At 601 it is determined that a first jack plug has been inserted in a corresponding first jack port. At 602, it is determined whether a contact in the first jack port corresponding to the sleeve S of a 3-pole jack plug or Ring2 R2 of a 4-pole jack plug is grounded and, if this contact is grounded, at 603, the process comprises determining whether a contact corresponding to the sleeve S of a 4-pole jack plug is grounded. If this contact is also grounded then the process may determine, at 604, that the jack plug is a 3-pole jack plug (for example a HP or LL 3-pole jack plug) following which it is determined whether an audio input is present at the tip T or ring R and, if so, the device is classified as a 3-pole SLI (at steps 605 and 606) as above for FIGS. 5-5b.

If, at 602, it is determined that there the contact in the first jack port corresponding to the sleeve S of a 3-pole jack plug or Ring2 R2 of a 4-pole jack plug is not grounded then, at 606 it is determined whether a contact corresponding to the sleeve of a 4-pole jack plug is grounded. In other words, the process determines whether both of the contacts in the first jack port respectively corresponding to S/R2 or S of a 3 or 4 pole jack plug are grounded. The order of the steps depicted in the flowchart of FIG. 6 is exemplary only for the purposes of illustrating the process. It will be appreciated that it may be determined whether the contacts are grounded in any order, or even at the same time etc.

As described above, if both are grounded the process classifies the accessory as a 3-pole HP or LL, at 604.

If it is determined that the contact in the first jack port corresponding to the sleeve S of a 3-pole jack plug or Ring2 R2 of a 4-pole jack plug is not grounded but the contact corresponding to the sleeve S of a 4-pole jack plug is grounded then, at 607, the accessory and jack plug type are classified as a 4-pole OMTP device (e.g. a headset).

If it is determined that the contact in the first jack port corresponding to the sleeve S of a 3-pole jack plug or Ring2 R2 of a 4-pole jack plug is grounded but the contact corresponding to the sleeve of a 4-pole jack plug is not grounded then, at 608, the accessory and jack plug type are classified as a 4-pole CTIA device (e.g. a headset).

If it is determined that neither the contact in the first jack port corresponding to the sleeve S of a 3-pole jack plug or Ring2 R2 of a 4-pole jack plug nor the contact corresponding to the sleeve S of a 4-pole jack plug are grounded then the process finishes (in this instance the jack plug may be of another type).

Following the classification at 607 and 608 of the accessory type and jack plug as a 3-pole OMTO or CTIA headset, at 610 the impedance is measured and at 611 the accessory and jack plug type are determined based on the impedance measurement. For example, low impedance loads may indicate that the accessory is a headphone accessory, and high impedance loads may indicate that the accessory is a line load(s) or a high-impedance headphone accessory.

In other words, as the blocks 602, 603, and 606, indicate, the position of grounded lines (e.g. what contacts in the jack port are grounded) can determine whether a jack plug (within the jack port) is a 3-pole, a 4-pole CTIA, or a 4-pole OMTP.

Whilst the presence of an audio signal at the tip T or ring R of an audio jack plug may provide a strong indication that a SLI or SMIC is present, if an audio signal is not present, the present disclosure is still able to classify the type of accessory connected to a jack plug inserted into a jack port when such an audio signal is not present (the “NO” option emanating from steps 502 and 605 in the processes described above). This will now be described.

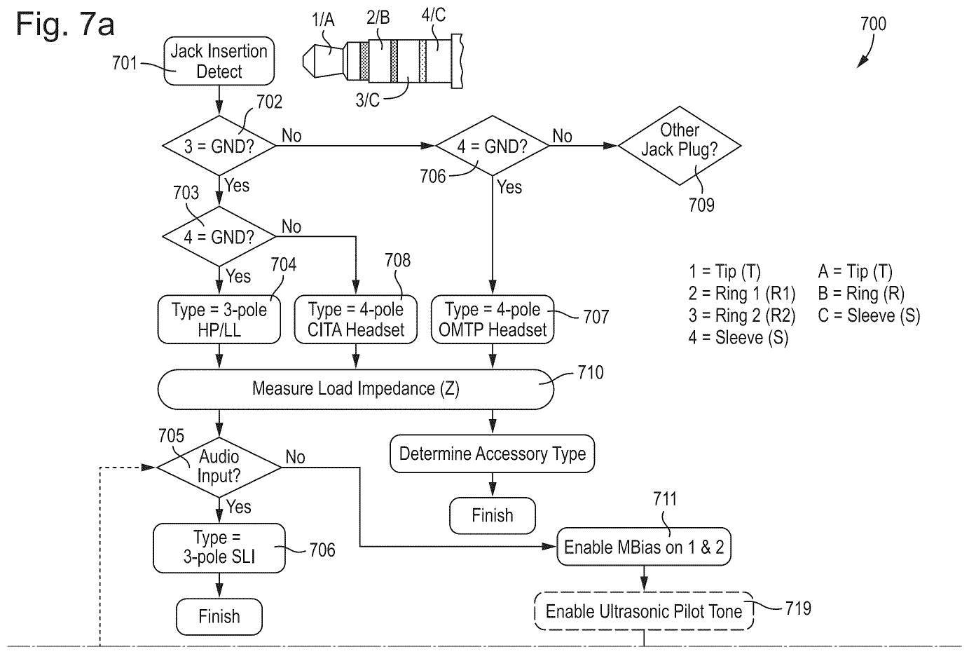

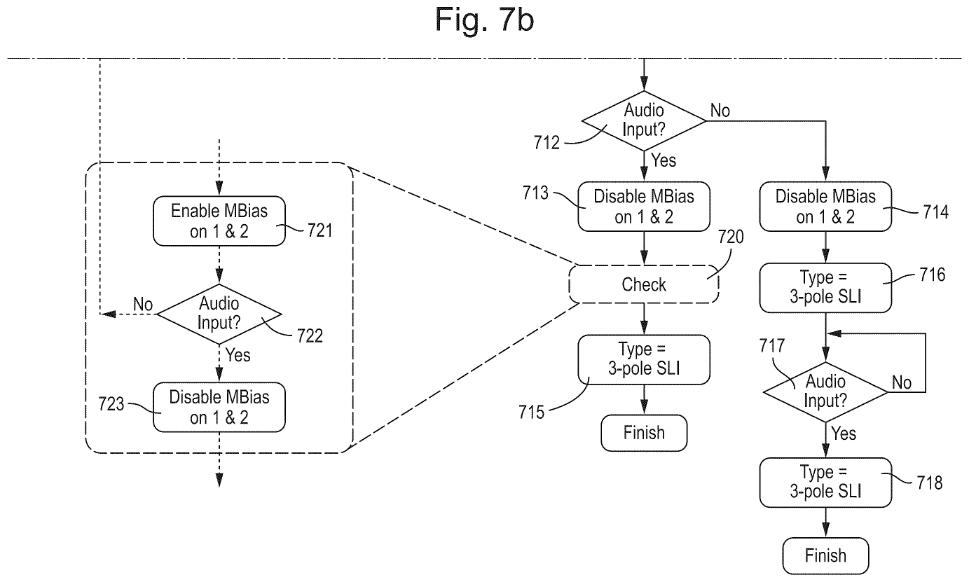

FIG. 7 illustrates a process 700, that incorporates the processes described above (like blocks of the process are denoted with like reference numerals so 701, for example, corresponds to 601 of FIG. 6 as described above etc.). Specifically, FIG. 7 illustrates the process following audio not being detected at the tip T or the ring R of the first jack plug (e.g. at steps 502, 605, and 705). If audio is not detected then, at 711, a microphone bias is enabled on the tip T and ring R. In an example this may be achieved by MBias circuitry. The MBias circuitry may be configured to increase the voltage across the tip T and ring R and may do so gradually (e.g. using a “soft ramp-up” technique) so as to reduce or prevent the presence of audible signal artefacts, i.e. pops or clicks, on headphone or line loads.

In response to the MBias, at 712, it is determined whether an audio signal is present on the tip T or the ring R (more specifically, whether an audio signal is detected at ADCs respectively connected to the contacts of a jack port corresponding to the tip T and ring R (or ring1 R1) of an audio jack plug. Either audio is present or not and, in either case, the MBias is disabled, as indicated at 713 and 714. If audio is present on the tip T or ring R in response to the MBias, then at 715 the accessory and jack port are classified as a 3-pole SMIC.

If audio is not present then, at 714, disabling the MBias may comprise gradually decreasing the voltage across the tip and ring gradually (e.g. using a “soft ramp-down” technique) so as to reduce the presence of pops or clicks, i.e., audible signal artefacts, on headphone or line loads.

Using a soft ramp-up/ramp-down technique may comprise gradually changing the voltage according to an S-curve slew rate which reduces, or eliminates, the audible components that could be otherwise superimposed onto the MBias voltage.

If audio is not present then, at 716, the accessory and audio jack plug are classified as a 3-pole HP/LL (this may be considered as treating the accessory type “by default” as a headphone or line load).

Following 716, at 717 the ADCs connected to the tip T and ring R (or R1) contacts on the jack port may continue to monitor for the presence of audio and, if they later detect audio (on either of the ADCs) then, at 718, the accessory may be reclassified as a SLI. In other words, steps 717 and 718 effectively monitor whether audio is subsequently (following 714) present at the tip T or the ring R of the audio jack plug.

At 719, the process may comprise an optional step of causing an ultrasonic tone (e.g. an ultrasonic pilot tone) to be enabled. This step in the process may be used to determine whether an audio signal is received at contacts connected to the tip T and ring R of the audio jack. In other words, the MBias enabled at 711 may allow the accessory device to be determined as an SMIC if the audio tone is detected at the contacts in the jack port connected to the tip T and ring R of the audio jack, but using an ultrasonic tone in addition to (or instead of) enables the SMIC to be reliably detected in a quiet environment and without the process being audible to the user. A further benefit of using an ultrasonic tone instead of, or in addition to, the enabled MBias is that the predetermined parameters and/or characteristics of the signal (e.g. frequency, amplitude, phase etc.) can be applied to the accessory type and this may simplify the detection process in some examples. In examples where an ultrasonic tone is enabled at 711 this may be disabled at a later stage in the process (e.g. at 713 or 714).

As will be described later, the ultrasonic tone may be transmitted via an “acoustic” path from one or more speakers of a host electronic device, received via the accessory device's SMICs, and then subsequently received by ADCs (e.g. respective ADCs connected to the left and right audio lines).

As stated above, the ultrasonic pilot tone may be generated when it is determined that the accessory device and/or the host device are in a quiet environment or the ultrasonic tone may be generated by the host device specifically for the purpose of gesture detect, e.g., detection of user presence and/or hand gestures and thus may simply be re-used and/or repurposed as part of the accessory type detection process.

The ultrasonic tone may be applied to one microphone (a transmit or “Tx” microphone) of the stereo microphones so as to cause it to operate like a speaker and the resulting ultrasonic output may then be detected using the other microphone (the receive or “Rx” microphone) of the stereo microphones; the Rx microphone being biased with the microphone bias voltage.

The use of stereo microphones, a Tx microphone and an Rx microphone, for accessory type detection relies on receiving a portion of the transmitted ultrasonic signal at the ADC connected to the Rx microphone. However, a return signal may also occur due to electrical feedback via a common ground impedance of the Tx and Rx microphones. Put another way, the ultrasonic tone may be transmitted via an acoustic path and also by an electrical path through components of the circuitry. To prevent false detection due to the common ground impedance when using stereo microphones, the delay between transmission and reception of the ultrasonic tone via the electrical path may be measured (e.g. during manufacture of the circuitry). A deviation from this electrical path delay during a field use jack plug detection scenario (e.g. performing the processes described above) may indicate an acoustic feedback path, i.e., the presence of a microphone. Therefore, the process may comprise determining a delay (e.g. a “round trip delay”) from a digital-to-analogue converter (DAC) to the ADC (e.g. calibrated at manufacturing time) and comparing this delay against the actual delay during the “live” jack-detection and classification process illustrated in FIG. 7, to determine whether feedback is likely due to the electrical and/or the acoustic path. This will again be described later.

At 715 the accessory device may be classified as a 3-pole SMIC but, as indicated by 720, an optional process to check or confirm that the device is an SMIC may be performed. According to this optional check process, at 721, a MBias is enabled on the contacts of the jack port corresponding to the tip T and ring R of a jack plug and, at 722, it is determined whether there is audio input present. If audio is present then, at 723 the MBias is disabled and the device is classified as an SMIC, at 715. If audio input is not present in response to this subsequently enabled MBias (or “subsequent MBias”) then the process returns to block 705. As stated previously, performing the optional steps 721-723 may ensure that the accessory device is an SMIC. The optional checking steps 720 may be performed for another ultrasonic tone (e.g. block 721 may comprise block 719 as described above).

It will be appreciated that at any point in the process a user may manually override any step and hence may manually override the process.

Circuitry for preforming the processes described above will now be described.

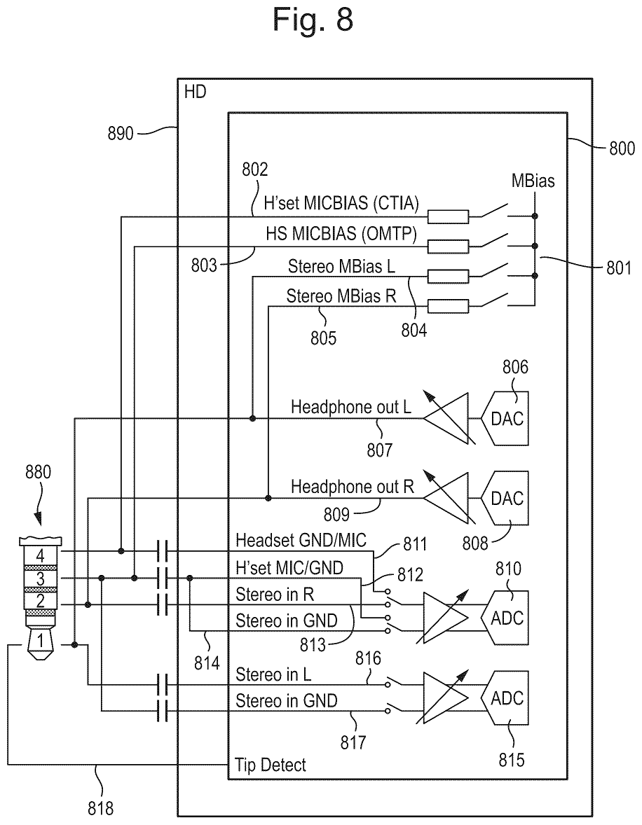

FIG. 8 schematically shows circuitry 800 implemented as part of a host device (HD) 890, the circuitry 800 being connected to the electrical contacts of a jack port in the host device and being configured to perform any of the processes described above. The circuitry 800 may comprise one or more integrated circuits, an audio processor and/or an audio codec.

Broadly speaking, the circuitry 800 comprises ADCs, DACs, circuitry for detecting the insertion and/or removal of a jack plug tip T in a jack socket, circuitry for detecting headset buttons (and user manipulation thereof), circuitry for detecting the type of jack plug (e.g. 4-pole CTIA or OMTP or 3-pole SMIC or SLI), circuitry permitting input/output stereo data signals on the tip T and ring R (or ring1 R1), and circuitry enabling a MBias voltage to be applied on the tip T and ring R (or ring1 R1) of the jack plug.

Components of the circuitry 800 will now be described in more detail. These components are shown as connected to a jack plug 880 via solid lines. Jack plug 880 is shown as a 4-pole TRRS jack plug but it will be appreciated that it could be a 3-pole TRS jack plug, as the circuitry 800 is configured to identify which and what type of accessory to which the jack plug 880 is connected. As such, while the solid lines indicated various components of the circuitry being connected to one of the four contacts of the depicted TRRS plug it will be appreciated that this is schematic and for illustrative purposes only. It will be appreciated that these components are connected to a contact in the jack port of the host device 890 that is configured to electrically connect to a respective contact (T, R1, R2, S or T, R, S) of a jack plug when inserted into the jack port. It will thus further be appreciated that a first contact in the jack port is configured to be electrically connected to the tip T of a 3-pole or a 4-pole jack plug when inserted in the jack port, a second contact in the jack port is configured to be electrically connected to the ring R of a 3-pole or to the ring1 R1 contact of a 4-pole jack plug when inserted in the jack port, a third contact in the jack port is configured to be electrically connected to the sleeve S of a 3-pole or to the ring2 R2 contact of a 4-pole jack plug when inserted in the jack port, and a fourth contact in the jack port is configured to be electrically connected to the sleeve S of a 4-pole jack plug when inserted in the jack port.

The circuitry 800 comprises a source of voltage bias, e.g. MBias, 801. A first headset bias line 802 is connected to the bias 801, via a resistor and switch, and is connectable to the sleeve S of a 4-pole jack plug. A second headset bias line 803 is connected to the bias 801, via a resistor and switch, and is connectable to the second ring R2 of a 4-pole jack plug or to the sleeve S of a 3-pole jack plug. A first stereo line 804 for left audio is connected to the bias 801, via a resistor and switch, and connectable to the tip T of a 3-pole or a 4-pole jack plug. A second stereo line 805 for right audio is connected to the bias 801, via a resistor and switch, and connectable to the ring R of a 3-pole jack plug or to the first ring R1 of a 4-pole jack plug.

The circuitry 800 comprises a first digital-to-analogue converter DAC 806 and a second digital-to-analogue converter DAC 808. A first headphone connection 807 for left headphone output is connected to the first DAC 806 and is connectable to the tip T of a 3-pole or a 4-pole jack plug. A second headphone connection 809 for right headphone output is connected to the second DAC converter 808 and is connectable to the ring R of a 3-pole jack plug or to the first ring R1 of a 4-pole jack plug.

The circuitry 800 comprises a first analogue-to-digital (ADC) converter 810 and a second analogue-to-digital (ADC) converter 815. A first headset connector 811 is connected to the first ADC 810 and is connectable to the sleeve S of a 4-pole jack plug. A second headset connection 812 is connected to the first ADC 810 and is connectable to the second ring R2 of a 4-pole jack plug or to the sleeve S of a 3-pole jack plug. A first stereo input line 813 for right stereo audio is connected to the first ADC 810 is and connectable to the ring R of a 3-pole jack plug or to the first ring R1 of a 4-pole jack plug. A first stereo input ground line 814 is connectable to the second ring R2 of a 4-pole jack plug or to the sleeve S of a 3-pole jack plug. A second stereo input line 816 for left stereo audio is connected to the second ADC 815 and is connectable to the tip T of a 3-pole or 4-pole jack plug. A second stereo input ground line 817 is connected to the second ADC 815 and is connectable to the second ring R2 of a 4-pole jack plug or to the sleeve S of a 3-pole jack plug.

Finally, indicated at 818, the circuitry comprises jack plug detect (or “sense”) circuitry. This may be tip T detect circuitry, ring R detect circuitry, or a combination of both.

The circuitry 800 of FIG. 8 is configured to perform the process described above with respect to FIG. 7 to enable the automatic detection of SMICs and SLIs connected to jack plugs inserted into a jack port connected to the circuitry. With reference to the process 700, on detection of a 3-pole jack plug the ADCs 810, 815 are enabled and if a relatively large audio signal is detected on the ADCs, the accessory type is identified as a stereo line-in (SLI) type accessory (see step 706). If an audio signal is not detected, the microphone bias voltage (MBias) is ramped up softly (e.g. to prevent audio artefacts as discussed above) on the tip T and ring 1 R1 (e.g. contacts/pins 1 and 2 in the jack socket), see the stereo lines 803 and 804 connected to the tip T and ring1 R1 contact and the MBias 801 (when their corresponding switches are closed). If a relatively large audio signal is then received at the ADCs (once the bias is stable), the accessory type is identified as an SMIC (see step 715).

The (MBias) voltage is then ramped down softly. As stated above, soft ramp-up and ramp-down is used to prevent pops and clicks, or the like, in the event that the accessory is a headphone or line-out load.

If these steps both fail to detect audio via the ADCs, then the accessory type is classified as a line/headphone type load by default (see step 716).

The detection process may continue indefinitely, with ADC outputs being continually monitored and then if an audio signal is detected on the ADCs, the accessory type is then re-classified as a line-input (LI) (see step 718) and the detection process ends.

In the event of user intervention (e.g. overriding the accessory type detection or enabling headphone playback), the detection process ends

As explained above with respect to step 720, the output of the ADCs 810, 815 may be controlled to perform a ‘check’ procedure (see steps 721-723) once the MBias ramp-down, i.e. disable, is complete so as to verify that any audio signal is no longer present at the ADCs which reduces the likelihood of a false detection in the event that a line-in (LI) signal is enabled during the type detection process and to ensure that the accessory device is a SMIC.

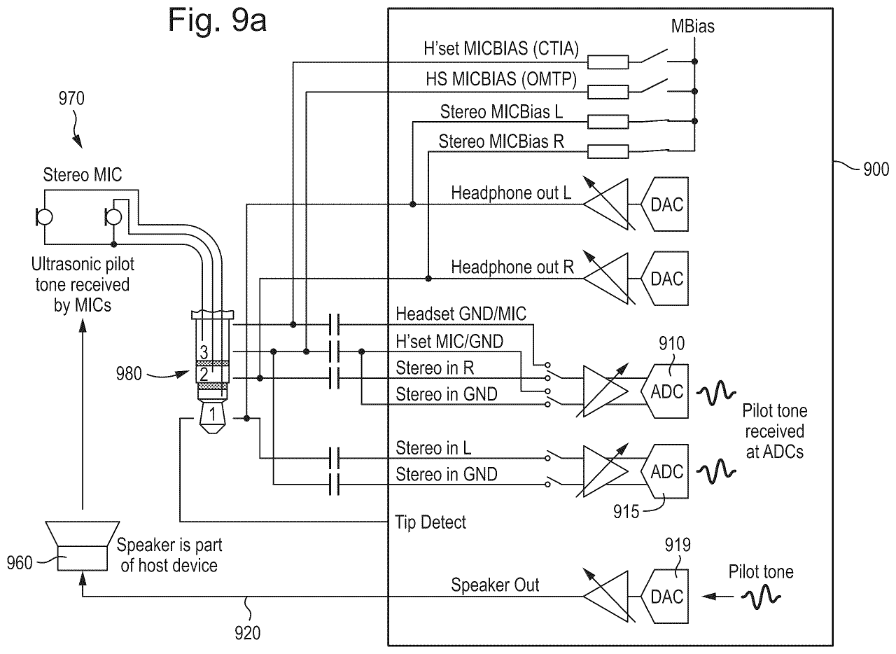

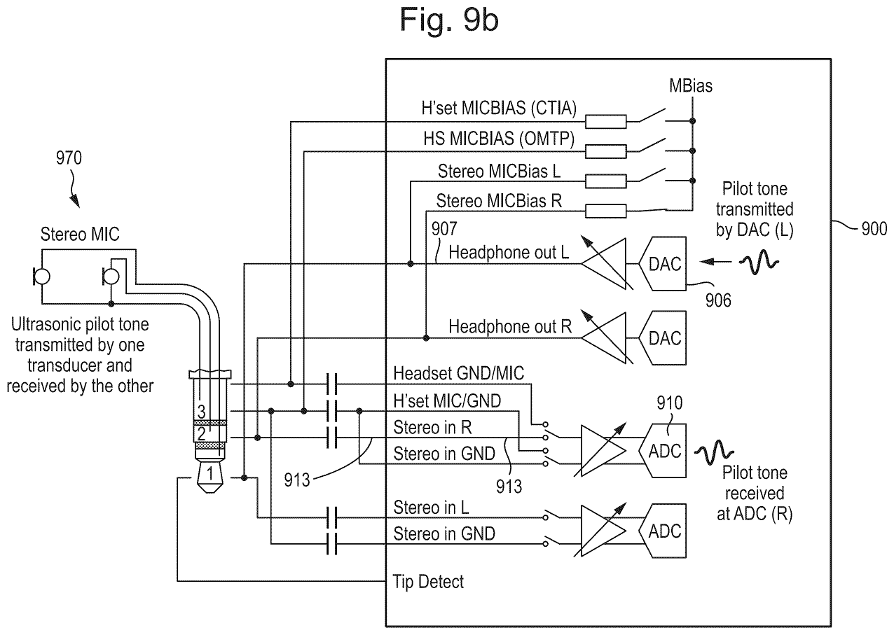

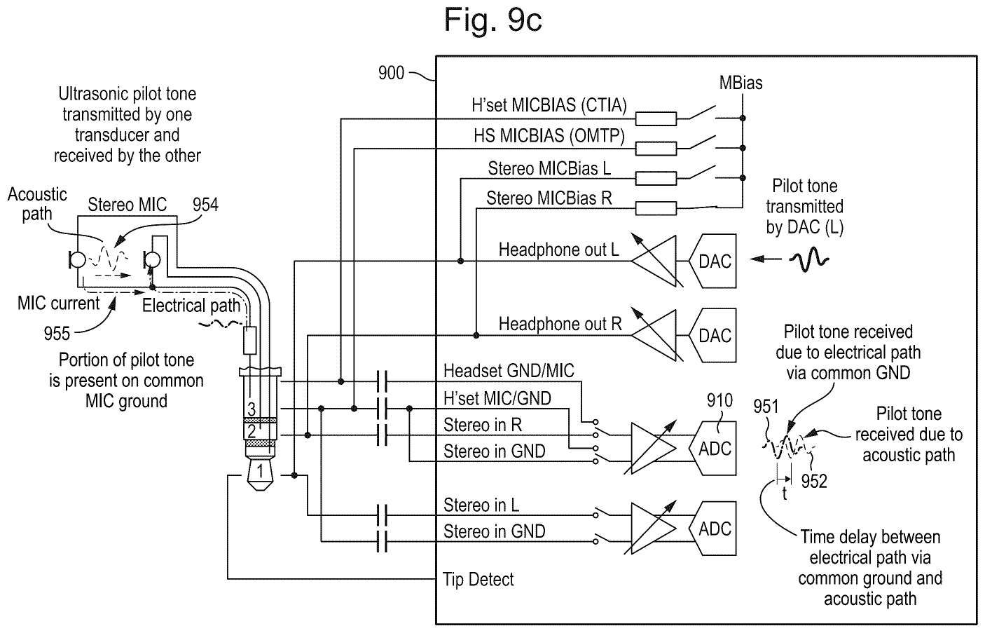

FIGS. 9a-c illustrate circuitry 900 which may be (or comprise) the same circuitry as 800, to illustrate the circuitry emitting, or generating, or transmitting etc., an ultrasonic tone.

FIG. 9a shows the circuitry 900 and audio jack plug 980 being connected to a SMIC 970. In this example the host device (not specifically indicated in FIG. 9a) comprises a speaker 960 and the circuitry 900 comprises a third DAC 919, a speaker output line 920, the DAC 919 being configured to output an audio signal to the speaker 960.

As described above with reference to step 719, the ultrasonic tone may be enabled by causing the DAC 919 to cause the speaker 960 to emit the ultrasonic tone. This is then received at the microphones of the SMIC and, via the connections described above with respect to FIG. 8, received at the ADCs 910, 915. As described above, this allows the SMIC to be identified as such in a quiet environment and without the host device being caused to emit an audible signal.

FIG. 9b shows the circuitry 900 without the third DAC 919 and speaker output line 920. The circuitry is this example is still capable of identifying the stereo accessory 970 as an SMIC by emitting an ultrasonic tone. In this example, the DAC 906 that is connected to the headphone output line 907 (in this example, for the output of the left headphone) causes the (left) headphone transducer in the SMIC to transmit the ultrasonic tone which is then received at the other (right) headphone transducer, and therefore at the ADC 910 via the stereo (right) input line 913.

It will be appreciated that in all of the diagrams of the circuitry reference to a “left” and “right” are purely for illustrative purposes and should not be construed as limiting. For example, the above description of FIG. 9b may be read to disclose that a DAC connected to one headphone output line (left or right) may cause one headphone transducer in the SMIC to transmit an ultrasonic tone which is received at the other headphone transducer and therefore at a corresponding ADC In the circuitry etc.

In other words, one microphone of the stereo microphones may be caused to operate as a “Tx” microphone, operating like a speaker, to output the ultrasonic tone received at the other “Rx” microphone (biased by the MBias).

FIG. 9c schematically illustrates the time delay as discussed above with respect to FIG. 7. Indicated at 954 is the acoustic path on which the emitted ultrasonic tone will travel from the Tx transducer to the Rx transducer, while 955 indicates the electric path on which a return signal may also be transmitted, back to the ADC 910 due to electrical feedback via a common ground impedance of the Tx and Rx microphones. This delay may be predetermined. The circuitry may be configured to compare the actual delay (detected during live detection) to determine the cause of feedback, as a deviation from this electrical path delay during a field use jack plug detection scenario may indicate an acoustic feedback path, i.e., the presence of a microphone.

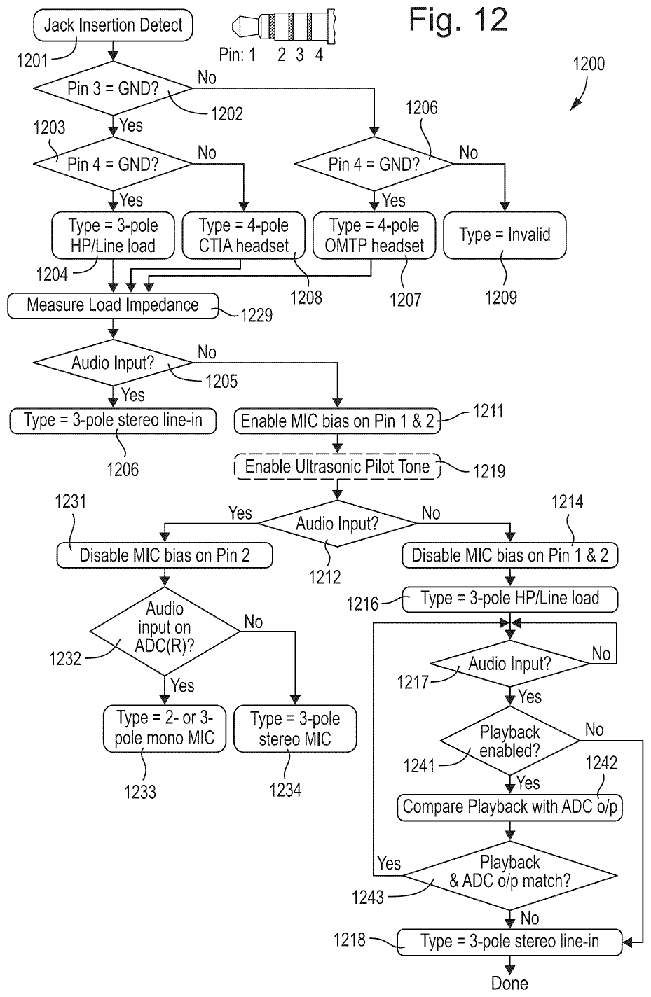

FIG. 12 illustrates a process 1200, that incorporates the processes described above (like blocks of the process are denoted with like reference numerals so 1201, for example, corresponds to 601 and 701 of FIGS. 6 and 7 as described above etc.). Specifically, FIG. 12 illustrates two parts of the process, the first relating to the capability of the process of this disclosure for the ongoing detection of a stereo line-in (SLI) accessory during playback. The second relates to the detection of a Mono Microphone (Mono MIC) accessory (e.g. connected to a 2-pole or 3-pole jack plug).

As for block 717 of FIG. 7, at block 1217 it is determined whether there is audio input present at ADCs connected to the tip T and ring (R or R1) contact of the jack port that has a jack plug therein.

If there is no audio present then blocks 1217 an onward may represent re-evaluating the type of accessory. At block 1241 the process comprises determining whether playback is enabled (e.g. whether the headphone amplifier is enabled). This may comprise determining whether a DAC associated with the headphone is outputting data (or at least one DAC each associated with a respective headphone, e.g. for left/right headphones). If not then the accessory is classified (at 1218) as a 3-pole SLI accessory (also see blocks 716 and 717 of the process 700). If it is determined that playback is enabled then at 1242 the process comprises comparing the playback with the ADC output (e.g. output data). This may comprise comparing ADC output data with DAC output data. It is then determined whether they match (at 1243). If the playback and ADC output data do not match then the accessory is classified (at 1218) as a 3-pole SLI accessory. If the playback and ADC output data do match then the method returns to block 1217 where it determines whether there is audio input on either of the ADCs connected to pins 1 and 2 (it will be understood that pin 1 refers to the tip T, pin 2 refers to the ring R or ring1 R1 (depending on the accessory type etc.)

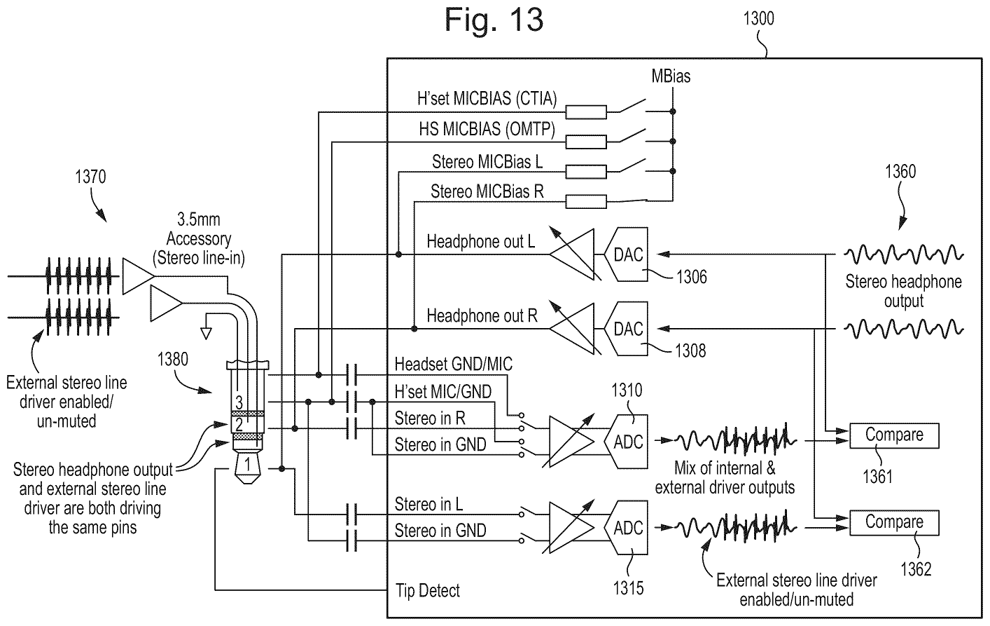

FIG. 13 illustrates circuitry 1300 (which may comprise the circuitry 800, 900 as described above with reference to FIGS. 8 and 9). FIG. 13 shows circuitry 1300 configured to perform the blocks 1241-1243 as described above. During playback, the digital ADC 1310, 1315 output data is compared (e.g. continually compared), by comparators 1361, 1362, with the digital headphone playback data (received at the DACs 1306, 1308). For example, each comparator 1361, 1362 is connected to, and configured to receive signals from, one of the DACs and one of the ADCs. Each comparator 1361, 1362 may therefore be configured to correlate the signals received from the ADC and DAC to which it is connected. When the ADC output is a mix of audio data output by the headphone amplifier and by the external line driver there will be a mismatch between the two signals which will be reported to the host system as a change in accessory type (replacing the default assumption of HP/LL (see 1216) with SLI). At 1370 the enabling (or unmuting) of the external stereo line driver is schematically indicated and at 1360 the stereo headphone output is schematically indicated.

The above blocks 1241-1243 and the circuitry 1300 solves the following potential problem. If a stereo LI accessory is inserted into the host device but the external line driver is mute then, due to the absence of a signal, the device could report the accessory type as a HP/LL (see the default classification at 1216). Then, if the device enables the headphone amplifier (e.g. to play music or to output alert tones etc.), for example following user input, then the external line driver is un-muted while the internal headphone amplifier is active. In this case, the external line driver and the internal headphone amplifier will both be attempting to drive the same lines. This may cause two problems. Firstly, the device's audio output may be routed via the headphone amplifier instead of to its loudspeakers (tones and other content intended to be audible to the user may not therefore be heard because the headphone amplifier is not actually driving the headphones). Secondly, the external line driver may still not be recognised as a line-in accessory. The steps 1241-1243 of the process 1200 resolve this potential issue.

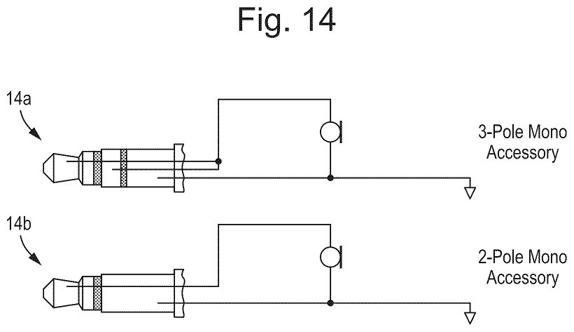

FIG. 14 illustrates, at 14a, a mono accessory connected to a 3-pole jack plug and, at 14b, a mono accessory connected to a 2-pole jack plug. In each example the mono accessory is illustrated as a mono microphone.

With reference again to FIG. 12, the process 1200 is able to distinguish between a mono and a stereo microphone (e.g. mono and stereo microphone inputs) as follows. These parts of the process use the fact that mono microphones require only one MICBias channel and one ADC channel to be enabled.

Referring to block 1212 (and see also block 712), it is determined whether audio input is present at either of the ADCs connected to pins 1 and 2 (respectively corresponding to the tip T or the ring R or R1). If there is audio present then at 1231 the process 1200 comprises disabling the MBias on pin 2 (e.g. the MBias applied to the ring), and disabling the MBias on pin 2 only, e.g. so that MBias remains on pin 1 (e.g. remains applied to the tip). At 1232, the process determines whether there is audio input at the ADC connected to pin 1. In one example this may be the ADC connected to the right stereo input line (with reference to FIG. 8). If there is no audio detected on this ADC then, at 1234, the accessory is classified as a 3-pole stereo microphone (see also block 715). On the other hand, if there is audio input present at the ADC then, at 1233, the accessory is classified as a mono MIC (either a 2-pole or a 3-pole mono MIC).

According to blocks 1231-1234 of the process, when audio input is detected after enabling both MicBias, the presence of a mono MIC is detected by disabling the MicBias on pin 2 and if an audio signal is still received at the ADC corresponding to pin 2 then it is assumed that pin1 an pin2 are shorted (hence the MIC on pin 2 is biased by the MicBias on pin 1), whereas if audio is not detected at the ADC corresponding to pin 2 then a stereo MIC is assumed.

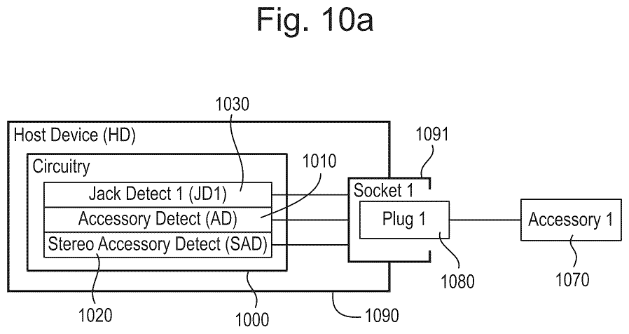

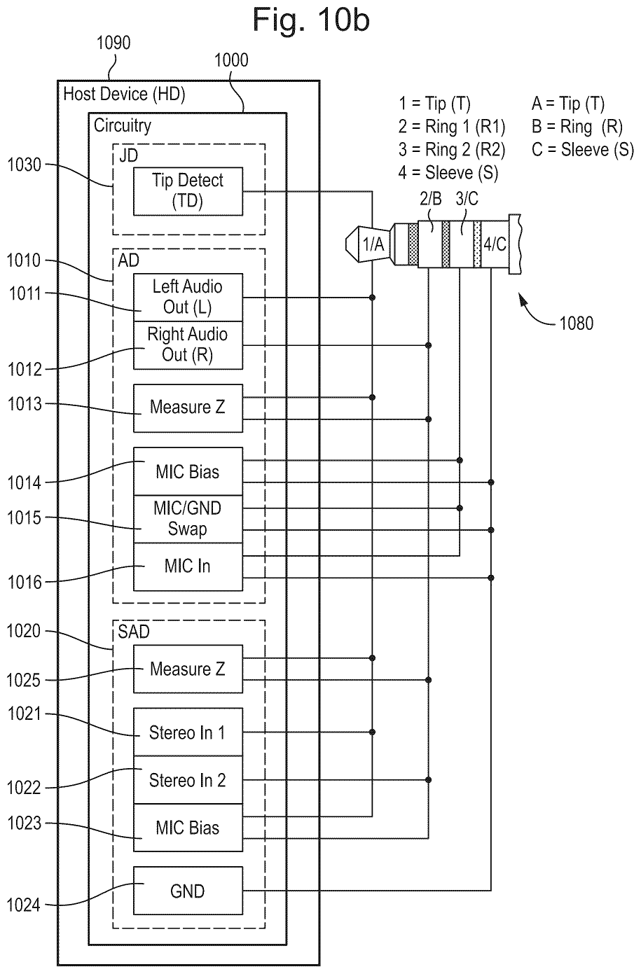

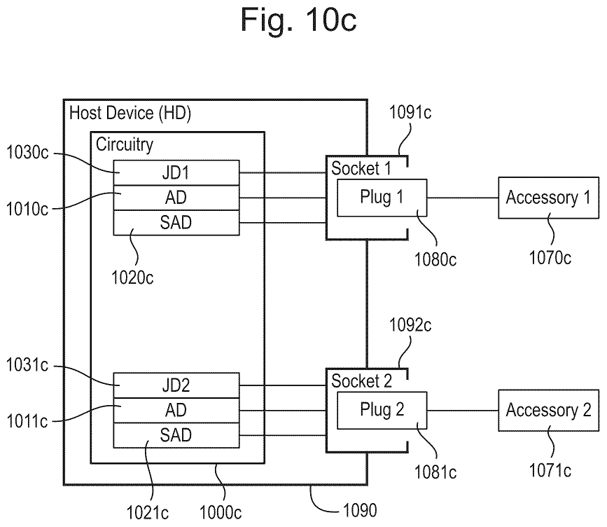

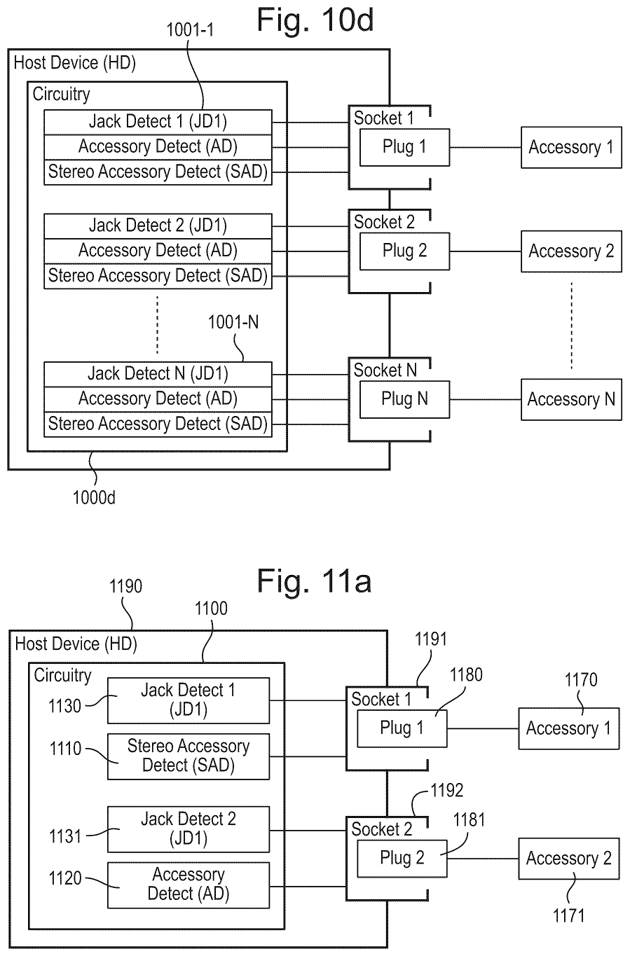

FIGS. 10a and 10b illustrate circuitry 1000 as part of a host device (HD). The circuitry 1000 may comprise the circuitry 800, 900 or 1300 as described above. FIG. 10a illustrates the circuitry more schematically while FIG. 10b illustrates the circuitry in more detail. Individual blocks, or units, or modules, of the circuitry are schematically shown but it will be understood that their depiction as separate entities is schematic and for purely illustrative purposes. Indeed, these blocks are depicted as separate merely to convey a function that the circuitry is configured to perform and not intended to depict that the components of the circuitry for performing one function are distinct from that of another etc.

Circuitry 1000 comprises an accessory detect (“AD”) module 1010 and a stereo accessory detect (“SAD”) module 1020, meaning that the circuitry 1000 has the functionality (e.g. is configured) to detect a type of 4-pole jack plug/accessory, e.g. CTIA or OMTP (via the AD module 1010), and to detect a type of 3-pole jack plug/accessory, e.g. SLI or SMIC (via the SAD module 1020). FIG. 10a shows the jack port 1091 of the host device receiving a jack plug 1080 which is connected to an accessory 1070, whereas FIG. 10b shows, schematically, the circuitry modules' various connections to a schematic jack plug 1080 but it will be understood that these module's are electrically connected to respective contacts on a jack port of the host device that is configured to receive the jack plug (e.g. a first contact corresponding to the tip T of a 3 or 4-pole jack plug when inserted in the jack port, a second contact corresponding to the ring R of a 3-pole or ring1 R1 of a 4-pole jack plug, a third contact corresponding to the sleeve S of a 3-pole or ring2 R2 of a 4-pole jack plug, and a fourth contact corresponding to the sleeve S of a 4-pole jack plug).

The AD circuitry 1010 comprises left audio out circuitry 1011 (e.g. circuitry for processing left audio output—see the DAC 806 and headphone left output line 807 in FIG. 8), right audio out circuitry 1012 (e.g. circuitry for processing right audio output—see the DAC 808 and the headphone right output line 809), impedance measurement circuitry 1011 configured to measure the impedance of any of the electrical connections, microphone biasing circuitry 1013 (see 801, 802, and 803), microphone and ground switching circuitry 1014 (see ADC 810 and lines 811 and 812), and microphone input circuitry 1015 (see ADC 810 and lines 811 and 812).

The SAD circuitry 1020 comprises a first stereo input circuitry 1021 for processing a first stereo input signal, a second stereo input circuitry 1022 for processing a second stereo input signal (see 810 and 815, lines 813 and 816), impedance measurement circuitry 1025 configured to measure the impedance of any of the electrical connections, microphone biasing circuitry 1023 (see 801, 804, and 805), and ground circuitry 1024 (see ADCs 810 and 815 and lines 814 and 817).

FIGS. 10a and 10b show one jack port connected to circuitry 1000 for determining what kind of accessory is connected to a jack plug that is received in the jack port. However, the principles of the above disclosure apply to any number of jack ports. Put another way, a host device may comprise more than jack port and the host device may comprise one “copy” or “version” of the circuitry 1000 (e.g. each of the modules and/or components thereof) for each jack port to determine the type of accessory connected to a jack received in each jack port. If the circuitry 1000 is part of one integrated circuit (“IC”) then the host device may comprise one IC for each jack port to identify the type of each accessory that is connected to the host device via its jack ports, or indeed a single IC may comprise multiple “copies” of the circuitry 1000.

FIG. 10c schematically shows an arrangement of circuitry 1000c having a number, N, of circuitry modules 1001-1, . . . , 1001-N, each configured to detect the insertion of a jack plug in a corresponding jack port and configured to detect whether the jack plug is connected to an accessory (such as a 4-pole CITA or OMTP accessory) or a stereo accessory (SMIC or SLI) as described above. In other words, each one of the modules 1001 may comprise the three modules 1010, 1020, and 1030 of FIG. 10a, each associated with a respective jack port (e.g. in a host device).

The circuitry 1000 advantageously permits a host device to accept a plurality of stereo and non-stereo accessories, thereby permitting a host device to be used by a gaming user, for example, wishing to play on a network or on-line with other players and at the same time stream on the internet. Indeed, any other users (such as family/friends etc.) may join in the gaming/streaming if the host device has further jack ports.

In one example the circuitry 1000 may be configured in such a way that it can detect and classify a first type of accessory connected to a 4-pole jack plug and a second type of accessory connected to a 3-pole jack plug. This is particularly advantageous for a host device comprising one jack port for a headset and another jack port for a SLI accessory. This will now be described.

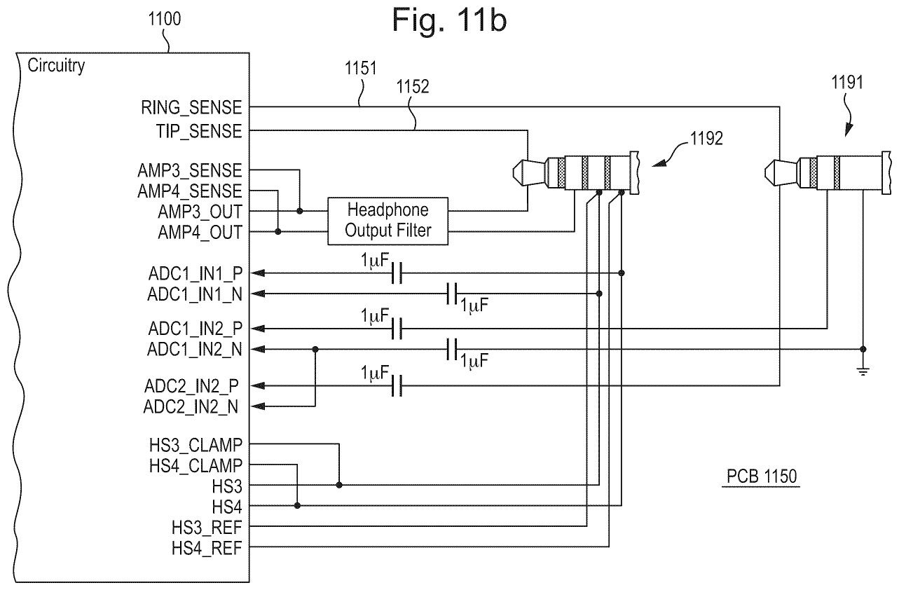

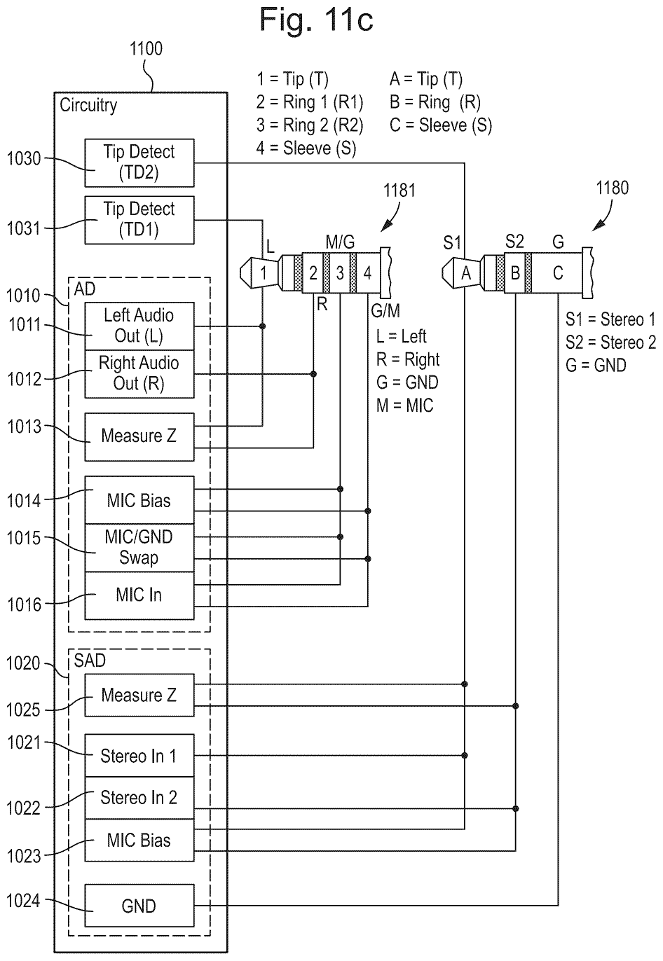

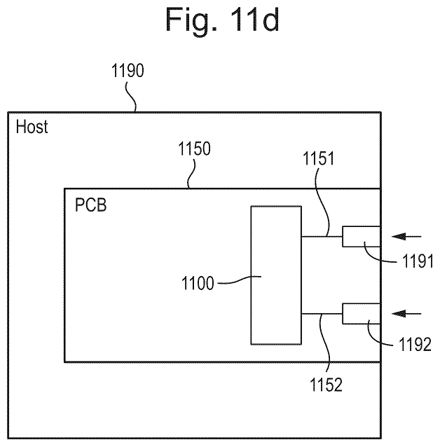

FIG. 11a illustrates schematically circuitry 1100 comprising the modules as described above with respect to FIG. 10a but the circuitry 1100 is implemented in a host device 1190 comprising two jack ports 1191, 1192, respectively being a dedicated input for stereo accessories and non-stereo accessories. Therefore, the host device 1190 is configured to connected to two accessory devices 1170, 1171 via respective electrical connections between its jack ports 1191, 1192 and respective jack plugs 1180, 1181. Like the circuitry 1000 of FIG. 10, the circuitry 1100 has an AD module 1110 and a SAD module 1120 but unlike FIG. 10, each one of the AD and SAD modules 1110, 1120 is routed to a different jack port. In this way, the circuitry 1100 is able to detect a type of accessory connected to a 3-pole jack plug received in a first jack port 1191 and a type of accessory connected to a 4-pole jack plug received in a second jack port 1192, by performing the process as set out in FIG. 7. Put another way the circuitry 1100 (e.g. the AD module 1110 thereof) may, by performing steps 701-711) determine that the accessory 1171 is a CTIA headset or OMTP headset, and the circuitry 1100 (e.g. the SAD module 1120) thereof) may, by performing steps 705-718 (including any of the steps 719 or 720 etc.) determine that the accessory 1170 is a SMIC or SLI accessory.

Connected to each respective port is a jack detect module 1130 and 1131. The first jack detect module 1130 is configured to detect the insertion and/or removal of a first jack plug 1180 tip in the first jack port 1191 and the second jack detect module 1131 is configured to detect the insertion and/or removal of a second jack plug tip 1181 in the second jack port 1192.

The jack detect module of some circuitry comprises a tip T detect (or tip T sense) and a ring R detect (or ring R sense). The tip T detect circuitry is to detect the insertion and/or removal of a jack plug tip T in a jack port and the ring R detect circuitry is to detect the insertion and/or removal of a jack plug ring (e.g. R or R1) in the (same) jack port. However, according to this disclosure there is provided a printed circuit board arrangement that routes the tip T detect circuitry to a first jack port and the ring R detect circuitry to a second jack port, thereby enabling the same circuitry to detect the presence of two jack plugs in respective jack ports.

FIG. 11b schematically shows a carrier 1150, such a printed circuit board (“PCB”) or ceramic motherboard. According to this arrangement, the carrier or carrier 1150 comprises first and second conductive paths, 1151 and 1152 which respectively electrically couple circuitry 1100 with respective first and second jack ports, respectively indicated by 1191 and 1192 (although indicated by a jack plug it will be appreciated that this is schematic and intended to indicate to which contacts on a respective jack ports that the circuitry is connected). This configuration of the PCB takes advantage that within the circuitry the ring R detect/sense circuitry can be effectively re-purposed as tip T detect circuitry and thereby circuitry which may have been employed to detect the insertion and/or removal of (the tip T and the ring R of) a jack plug in a jack port can be utilised to detect the insertion and/or removal of two jack plugs in respective jack ports.

In this way, the circuitry may be considered to comprise first and second tip detect circuitries each configured to detect the insertion and/or removal of a respective jack plug in a jack port. Equally, the circuitry may be considered to comprise tip T detect circuitry configured to detect the insertion and/or removal of a first jack plug in a first jack port, and ring R detect circuitry configured to detect the insertion and/or removal of a second jack plug in a second jack port. Therefore, the ring R detect circuitry may be configured to detect the insertion and/or removal of a respective jack plug in a jack port. The terminology “ring R detect/sense” and “tip T detect/sense” may therefore be considered interchangeable in some instances that will be apparent to the skilled person from the example.

According to the arrangements shown in FIGS. 11a and 11b the carrier 1150 can therefore be considered to support a first module 1110 (see “RING_SENSE” in FIG. 11b) and a second module 1130 (see “TIP_SENSE” in FIG. 11b) respectively configured to detect the at least partial receipt of respective jack plugs in respective jack ports, with the conductive paths 1151 and 1152 connecting these modules with the respective jack ports (see the lines connecting the modules 1130 and 1131 with the “sockets” 1191 and 1192 of FIG. 11a).

The carrier 1150 may comprise the circuitry 1100 and/or may comprise at least one of the jack ports 1191, 1192. It will be appreciated that, in an example, any or all of the components of the FIG. 11b arrangement may be provided on a monolithic structure, e.g. a monolithic PCB.

FIG. 11c shows the circuitry 1100 in more detail in the example where the circuitry is for dedicated jack ports, one for stereo accessories and one for non-stereo accessories. Like reference numerals are denoted with like reference numbers with reference to FIG. 10b. Like FIG. 10b, the circuitry 1100 comprises a tip detect (TD) module, an audio detect (AD) module 1110, and an stereo audio detect (SAD) module 1120 but, unlike FIG. 10b, the circuitry 1100 is electrically connected (e.g. via a PCB, i.e. a carrier, arrangement described above with reference to FIG. 11a) to two jack ports (schematically indicated by the jack plugs 1180, 1181). Put another way, by virtue of a carrier that comprises conductive paths to electrically connect a TIP_SENSE to a first jack port and a RING_SENSE to a second jack port (where it may be configured to detect the presence of a tip T of a second jack plug in the second jack port), the circuitry 1100 may be configured to detect the presence of two jack plugs, thereby being compatible with a device comprising two jack ports. In this example, as for FIGS. 11a and b, to illustrate the application of the circuitry 1100 the device is shown receiving a 4-pole jack plug 1181 and a 3-pole jack plug 1180 but, with reference again to FIG. 10c, the principles of this disclosure may be applied to host devices having any number of jack ports.

FIG. 11d shows a general carrier 1150 to illustrate the general principles of the disclosure, of which FIGS. 11a-c depict one example. FIG. 11d shows a carrier 1150 implemented in a host device 1190, the host device comprising two jack ports 1191 and 1192. In the FIG. 11a-c examples these were dedicated stereo and non-stereo accessory ports but FIG. 11d shows that they may be non-dedicated ports. In the FIG. 11d example these two ports 1191,1192 remain connected to circuitry 1100. More specifically, the carrier 1150 comprises first and second conductive paths 1151, 1152 each electrically connecting a respective port 1191, 1192 to the circuitry 1000.

The arrangement of the circuitry 1000 may, of course, be as depicted in FIG. 11a-c in the examples where the ports 1191, 1192 are respectively dedicated for stereo and non-stereo accessories but the principles of this disclosure are equally applicable to a device having two “general” jack ports (e.g. not being “dedicated” jack ports and being able to accept stereo and non-stereo accessories. This will now be described. The circuitry 1100 of FIG. 11d may comprise the arrangement of FIG. 10c above, but utilising the principles described above with reference to FIG. 11a-c, the jack detect circuitry, or module, “JD2,” 1031c may comprise the “RING_SENSE” module of the circuitry as described above. Put another way, the TIP_SENSE and RIG_SENSE of the circuitry 1000 may be connected to the ports 1091c, 1092c and each of those ports may be connected to both a stereo accessory module (SAD) and an accessory detect module (AD), in this way the process described above with reference to FIGS. 5-7 may be performed by the circuitry 1000 for each port 1901, 1092, and the insertion of a jack plug in each port may be as described above with reference to FIGS. 11a-c (with the tip detect module of the circuitry 1000 detecting the insertion of one jack plug in one jack port and the ring detect module of the circuitry 1000 detecting the insertion of the other jack plug in the other jack port.

In other words, depending on the intended design of the host device, the circuitry can be used in conjunction with two jack ports and may comprise two SAD modules (if it is known in advance that the device is intended to support two stereo accessories), two AD modules (if it is known in advance that the device is intended to support two headphone/microphone type accessories), or one SAD and one AD (if it is known in advance that the device is intended to support one of each type of accessory), and in each example the circuitry 1100, by virtue of its two “jack detect” modules, has the functionality to detect the insertion of both jack plugs. Of course, for other arrangements, such as where the type of accessory is not known in advance, circuitry such as that depicted in FIGS. 10a-c could be used; however the advantage of the FIG. 11a-e arrangements is that one IC (for example) can be used to detect the insertion of two jack plugs, by virtue of the PCB arrangement disclosed in FIG. 11b.

All examples and conditional language recited herein are intended for pedagogical objects to aid the reader in understanding the disclosure and the concepts contributed by the inventor to furthering the art and are construed as being without limitation to such specifically recited examples and conditions.

The skilled person will thus recognise that some aspects of the above-described circuitry, apparatus and methods may be embodied as processor control code, for example on a non-volatile carrier medium such as a disk, CD- or DVD-ROM, programmed memory such as read only memory (Firmware), or on a data carrier such as an optical or electrical signal carrier. For many applications, embodiments as herein described may be implemented on a DSP (Digital Signal Processor), ASIC (Application Specific Integrated Circuit) and/or FPGA (Field Programmable Gate Array). Thus, any code may comprise conventional program code or microcode or, for example code for setting up or controlling an ASIC or FPGA. Any code may also comprise code for dynamically configuring re-configurable circuitry and/or apparatus such as re-programmable logic gate arrays. Similarly, any code may comprise code for a hardware description language such as Verilog™ or VHDL (Very high-speed integrated circuit Hardware Description Language). As the skilled person will appreciate, any code may be distributed between a plurality of coupled components in communication with one another. Where appropriate, the embodiments herein described may also be implemented using code running on a field-(re)programmable analogue array or similar device in order to configure analogue hardware.

It should be noted that the above-mentioned embodiments illustrate rather than limit any invention herein contained, and that those skilled in the art will be able to design many alternative embodiments without departing from the scope of the appended feature statements and/or claims. The word “comprising” does not exclude the presence of elements or steps other than those listed in a feature statement and/or claim, “a” or “an” does not exclude a plurality, and a single feature or other unit may fulfil the functions of several units recited in the feature statements and/or claims. Any reference numerals or labels in the feature statements and/or claims shall not be construed so as to limit their scope.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

Examples of this disclosure may be provided according to any one of the following numbered statements:
1. Circuitry for detecting a type of accessory connected to a first jack plug inserted into a first jack port, the circuitry being configured to:
   determine whether an audio signal is present at the tip or the ring of the first jack plug; and, if there is an audio signal present at the tip or the ring of the first jack plug,
   determine that the type of accessory is a stereo line-in accessory connected to a 3-pole jack plug.
2. Circuitry of statement 1, wherein the circuitry is further configured to, if no audio signal is present at the tip or the ring of the first jack plug:
   enable a microphone bias to be applied to the tip and the ring of the first jack plug; and
   determine whether an audio signal is present at the tip or the ring of the first jack plug in response to the microphone bias; and, if there is an audio signal present in response to the microphone bias,
   determine that the type of accessory is a stereo microphone.
3. Circuitry of statement 2, wherein the circuitry is further configured to, if there is no audio signal present in response to the microphone bias:
   determine that the type of accessory is a headphone and/or a line load.
4. Circuitry of statement 2, wherein the circuitry is further configured to:
   disable the microphone bias; and to check whether the type of accessory is a stereo microphone, wherein, to perform the check, the circuitry is configured to:
   re-enable the microphone bias to the tip and the ring of the first jack plug;
   determining whether an audio signal is present at the tip or the ring of the first jack plug in response to the re-enabled microphone bias.
5. Circuitry of statement 4, wherein the circuitry is further configured to, if there is an audio signal present at the tip or the ring of the first jack plug in response to the re-enabled microphone bias:
   confirm that the type of accessory is a stereo microphone.
6. Circuitry of statement 1, wherein the circuitry is further configured to, if no audio signal is present at the tip or the ring of the first jack plug:
   enable a microphone bias to the tip and the ring of the first jack plug; and
   determine whether an audio signal is present at the tip or the ring of the first jack plug in response to the microphone bias; and, if there is an audio signal present in response to the microphone bias:
   disable the microphone bias applied to the ring of the first jack plug
   determine whether audio input is present on the tip of the first jack plug; and, if there is audio input present on the tip of the first jack plug,
   determine that the type of accessory is a mono microphone connected to a 2-pole or to a 3-pole jack plug; and, if there is no audio input present on the tip of the first jack plug,
   determine that the type of accessory is a stereo microphone.
7. Circuitry of statement 3, wherein the circuitry is further configured to:
   disable the microphone bias; and
   determine whether an audio signal is present at the tip or the ring of the first jack plug and, if there is an audio signal present:
   reclassify the type of accessory as a stereo line-in accessory.
8. Circuitry of statement 3, or 7 wherein the circuitry is configured to:
   disable the microphone bias;
   determine whether playback is enabled on an accessory connected to the first jack plug;
   compare the output of one or more digital-to-analogue converters with the output of one or more analogue-to-digital converters;
   determine whether the digital-to-analogue converter output matches the analogue-to-digital converter output; and, if the outputs do not match,
   reclassify the type of accessory as a stereo line in accessory.
9. Circuitry of any preceding statement, the circuitry being further configured to, if no audio signal is present at the tip or the ring of the first jack plug:
   enable an ultrasonic tone; and
   determine whether the ultrasonic signal is present at the tip or the ring of the first jack plug in response to the ultrasonic tone; and, if the ultrasonic signal is present at the tip or the ring of the first jack plug,
   determine that the type of accessory is a stereo microphone.
10. Circuitry of statement 9, wherein the circuitry is further configured to, if no ultrasonic signal is present at the tip or the ring of the first jack plug in response to the ultrasonic tone:
   determine that the type of accessory is a headphone and/or a line load.
11. Circuitry of statement 9 or 10, wherein to enable the ultrasonic tone, the circuitry is configured to:
   cause the ultrasonic tone to be output from one or more speakers and/or causing a transducer to transmit the ultrasonic tone.
12. Circuitry of statement 11, wherein the circuitry is further configured to:
   determine a delay between the ultrasonic tone being received via the electrical path from the transducer and/or or speaker that output the ultrasonic tone and via an acoustic path between the transducer and/or speaker that output the ultrasonic tone and a transducer receiving the ultrasonic tone.
13. Circuitry of any of preceding statement further comprising:
   a first jack plug detect module configured to detect whether the first jack plug is received in the first jack port.
14. Circuitry of any preceding statement comprising a first circuitry module and a second circuitry module, wherein the first circuitry module comprises at least one of:
   left audio out circuitry;
   right audio out circuitry;
   impedance measurement circuitry;
   microphone biasing circuitry;
   microphone and ground switching circuitry; and
   microphone input circuitry;
and wherein the second circuitry module comprises at least one of:
   a first stereo input circuitry;
   a second stereo input circuitry;
   impedance measurement circuitry;
   microphone biasing circuitry; and
   ground circuitry.
15. Circuitry of any preceding statement, wherein the circuitry further comprises at least one of:
   a first source of voltage bias;
   a first headset bias line connected to the bias and connectable to the sleeve of a 4-pole jack plug;
   a second headset bias line connected to the bias and connectable to the second ring of a 4-pole jack plug or to the sleeve of a 3-pole jack plug;
   a first stereo line for left audio input connected to the bias and connectable to the tip of a 3-pole or a 4-pole jack plug;
   a second stereo line for right audio input connected to the bias and connectable to the ring of a 3-pole jack plug or to the first ring of a 4-pole jack plug;
   a first digital to analogue converter;
   a first headphone line for left headphone output connected to the first digital to analogue converter and connectable to the tip of a 3-pole or a 4-pole jack plug;
   a second digital to analogue converter;
   a second headphone line for right headphone output connected to the second digital to analogue converter and connectable to the ring of a 3-pole jack plug or to the first ring of a 4-pole jack plug;
   a first analogue to digital converter;
   a first headset line connected to the first analogue to digital converter and connectable to the sleeve of a 4-pole jack plug;
   a second headset line connected to the first analogue to digital converter and connectable to the second ring of a 4-pole jack plug or to the sleeve of a 3-pole jack plug;
   a first stereo input line for right stereo audio connected to the first analogue to digital converter and connectable to the ring of a 3-pole jack plug or to the first ring of a 4-pole jack plug; and
   a first stereo input ground line connectable to the second ring of a 4-pole jack plug or to the sleeve of a 3-pole jack plug;
   a second analogue to digital converter;
   a second stereo input line for left stereo audio connected to the second analogue to digital converter and connectable to the tip of a 3-pole or 4-pole jack plug;
   a second stereo input ground line connected to the second analogue to digital converter and connectable to the second ring of a 4-pole jack plug or to the sleeve of a 3-pole jack plug; and
   a third digital to analogue converter configured to output an audio signal to a speaker.
16. Circuitry according to any preceding statement, wherein the circuitry is further configured to detect a type of accessory connected to a second jack plug inserted into a second jack port, the circuitry being configured to:
   determine whether an audio signal is present at the tip or the ring of the second jack plug; and, if there is an audio signal present at the tip or the ring of the second jack plug,
   determine that the type of accessory is a stereo line-in accessory connected to a 3-pole jack plug.
17. Circuitry of statement 16, wherein the circuitry is further configured to, if no audio signal is present at the tip or the ring of the second jack plug:
   enable a microphone bias to the tip and the ring of the second jack plug; and
   determine whether an audio signal is present at the tip or the ring of the second jack plug in response to the microphone bias; and, if there is an audio signal present in response to the microphone bias,
   determine that the type of accessory is a stereo microphone.
18. Circuitry of statement 17, wherein the circuitry is further configured to, if there is no audio signal present in response to the microphone bias:
   determining that the type of accessory is a headphone and/or a line load.
19. Circuitry of statement 17, wherein the circuitry is further configured to:
   disable the microphone bias; and to check whether the type of accessory is a stereo microphone, wherein, to perform the check, the circuitry is configured to:
   re-enable the microphone bias to the tip and the ring of the second jack plug;
   determining whether an audio signal is present at the tip or the ring of the second jack plug in response to the re-enabled microphone bias.
20. Circuitry of statement 19, wherein the circuitry is further configured to, if there is an audio signal present at the tip or the ring of the second jack plug in response to the re-enabled microphone bias:
   confirm that the type of accessory is a stereo microphone.
21. Circuitry of statement 16, wherein the circuitry is further configured to, if no audio signal is present at the tip or the ring of the second jack plug:
   enable a microphone bias to the tip and the ring of the second jack plug; and
   determine whether an audio signal is present at the tip or the ring of the second jack plug in response to the microphone bias; and, if there is an audio signal present in response to the microphone bias:
   disable the microphone bias applied to the ring of the second jack plug
   determine whether audio input is present on the tip of the second jack plug; and, if there is audio input present on the tip of the second jack plug,
   determine that the type of accessory is a mono microphone connected to a 2-pole or to a 3-pole jack plug; and, if there is no audio input present on the tip of the second jack plug,
   determine that the type of accessory is a stereo microphone.
22. Circuitry of statement 17, wherein the circuitry is further configured to:
   disable the microphone bias; and
   determine whether an audio signal is present at the tip or the ring of the second jack plug and, if there is an audio signal present:
   reclassify the type of accessory as a stereo line-in accessory.
23. Circuitry of any of statement 18, wherein the circuitry is configured to:
   disable the microphone bias;
   determine whether playback is enabled on an accessory connected to the second jack plug;
   compare the output of one or more digital-to-analogue converters with the output of one or more analogue-to-digital converters;
   determine whether the digital-to-analogue converter output matches the analogue-to-digital converter output; and, if the outputs do not match,
   reclassify the type of accessory as a stereo line in accessory.
24. Circuitry of any of statements 16-23, the circuitry being further configured to, if no audio signal is present at the tip or the ring of the second jack plug:
   enable an ultrasonic tone; and
   determine whether the ultrasonic signal is present at the tip or the ring of the second jack plug in response to the ultrasonic tone and, if the ultrasonic signal is present at the tip or the ring of the second jack plug;
   determine that the type of accessory is a stereo microphone.
25. Circuitry of statement 24, wherein the circuitry is further configured to, if no ultrasonic signal is present at the tip or the ring of the second jack plug in response to the ultrasonic tone:
   determine that the type of accessory is a headphone and/or a line load.
26. Circuitry of statement 24 or 25, wherein to enable the ultrasonic tone, the circuitry is configured to:
   cause the ultrasonic tone to be output from one or more speakers and/or causing a transducer to transmit the ultrasonic tone.
27. Circuitry of statement 26, wherein the circuitry is further configured to:
   determine a delay between the ultrasonic tone being received via the electrical path from the transducer and/or or speaker that output the ultrasonic tone and via an acoustic path between the transducer and/or speaker that output the ultrasonic tone and a transducer receiving the ultrasonic tone.
28. Circuitry of any of statements 16-27 further comprising:
   a second jack plug detect module configured to detect whether the second jack plug is received in the first jack port.
29. Circuitry of any of statements 16-28 comprising a third circuitry module and a fourth circuitry module, wherein the third circuitry module comprises at least one of:
   left audio out circuitry;
   right audio out circuitry;
   impedance measurement circuitry;
   microphone biasing circuitry;
   microphone and ground switching circuitry; and
   microphone input circuitry;
and wherein the fourth circuitry module comprises at least one of:
   a first stereo input circuitry;
   a second stereo input circuitry;
   impedance measurement circuitry;
   microphone biasing circuitry; and
   ground circuitry.
30. Circuitry of any of statements 16-29, wherein the circuitry further comprises at least one of:
   a third source of voltage bias;
   a third headset bias line connected to the bias and connectable to the sleeve of a 4-pole jack plug;
   a fourth headset bias line connected to the bias and connectable to the second ring of a 4-pole jack plug or to the sleeve of a 3-pole jack plug;
   a third stereo line for left audio input connected to the bias and connectable to the tip of a 3-pole or a 4-pole jack plug;
   a fourth stereo line for right audio input connected to the bias and connectable to the ring of a 3-pole jack plug or to the first ring of a 4-pole jack plug;
   a third digital to analogue converter;
   a third headphone line for left headphone output connected to the third digital to analogue converter and connectable to the tip of a 3-pole or a 4-pole jack plug;
   a fourth digital to analogue converter;
   fourth headphone line for right headphone output connected to the fourth digital to analogue converter and connectable to the ring of a 3-pole jack plug or to the first ring of a 4-pole jack plug;
   a third analogue to digital converter
   a third headset line connected to the third analogue to digital converter and connectable to the sleeve of a 4-pole jack plug;
   a fourth headset line connected to the third analogue to digital converter and connectable to the second ring of a 4-pole jack plug or to the sleeve of a 3-pole jack plug;
   a third stereo input line for right stereo audio connected to the third analogue to digital converter and connectable to the ring of a 3-pole jack plug or to the first ring of a 4-pole jack plug;
   a third stereo input ground line connectable to the second ring of a 4-pole jack plug or to the sleeve of a 3-pole jack plug;
   a fourth analogue to digital converter;
   a fourth stereo input line for left stereo audio connected to the fourth analogue to digital converter and connectable to the tip of a 3-pole or 4-pole jack plug;
   a fourth stereo input ground line connected to the fourth analogue to digital converter and connectable to the second ring of a 4-pole jack plug or to the sleeve of a 3-pole jack plug; and
   a fifth digital to analogue converter configured to output an audio signal to a speaker.
31. A carrier comprising the circuitry of any of statements 1-30, wherein the carrier comprises a first conductive path configured to connect the circuitry to a first audio jack port and a second conductive path configured to connect the circuitry to a second audio jack port.
32. The carrier of statement 31 comprising the first and second audio jack ports.
33. A device comprising the circuitry of any of statements 1-30 or the carrier of statements 31 or 32.
34. A carrier comprising a first conductive path and a second conductive path, wherein the first conductive path is configured to electrically connect circuitry with a first jack port, and wherein the second conductive path is configured to electrically connect the circuitry with a second jack port.
35. The carrier of statement 34, wherein the circuitry comprises a first module configured to detect the insertion of a first audio jack in the first jack port and a second module configured to detect the insertion of a second jack plug in the second jack port, wherein the first conductive path is configured to electrically connect the first module with the first jack port, and wherein the second conductive path is configured to electrically connect the second module with the second jack port.
36. The carrier of statement 34 or 35 wherein the circuitry comprises tip detect circuitry and ring detect circuitry, wherein the first conductive path is configured to electrically connect the tip detect circuitry with the first jack port and wherein the second conductive path is configured to electrically connect the ring detect circuitry with the second jack port.
37. The carrier of statement 36 wherein the tip detect circuitry is configured to detect the full insertion of the first audio jack plug in the first jack port and wherein the ring detect circuitry is configured to detect the full insertion of the second audio jack plug in the second jack port.
38. The carrier of statement 34 or 35 wherein the circuitry comprises first tip detect circuitry and second tip detect circuitry, wherein the first conductive path is configured to electrically connect the first tip detect circuitry with the first jack port and wherein the second conductive path is configured to electrically connect the second tip detect circuitry with the second jack port.
39. The carrier of statement 38 wherein the first tip detect circuitry is configured to detect the full insertion of the first audio jack plug in the first jack port and wherein the second tip detect circuitry is configured to detect the full insertion of the second audio jack plug in the second jack port.
40. The carrier of any of statements 34-39 comprising the first and second audio jack ports.
41. The carrier of any of statements 34-40, comprising the circuitry.
42. The carrier of statement 41, wherein the circuitry is configured to detect a type of accessory connected to the first jack plug inserted into the first jack port, the circuitry being configured to:
   determine whether an audio signal is present at the tip or the ring of the first jack plug; and, if there is an audio signal present at the tip or the ring of the first jack plug,
   determine that the type of accessory is a stereo line-in accessory.
43. The carrier of statement 42, wherein the circuitry is further configured to, if no audio signal is present at the tip or the ring of the first jack plug:
   enable a microphone bias to be applied to the tip and the ring of the first jack plug; and
   determine whether an audio signal is present at the tip or the ring of the first jack plug in response to the microphone bias; and, if there is an audio signal present in response to the microphone bias,
   determine that the type of accessory is a stereo microphone.
44. The carrier of statement 43, wherein the circuitry is further configured to, if there is no audio signal present in response to the microphone bias:
   determining that the type of accessory is a headphone and/or a line load.
45. The carrier of statement 43, wherein the circuitry is further configured to:
   disable the microphone bias and to check whether the type of accessory is a stereo microphone, wherein, to perform the check, the circuitry is configured to:
   re-enable the microphone bias to the tip and the ring of the first jack plug;
   determining whether an audio signal is present at the tip or the ring of the first jack plug in response to the re-enabled microphone bias.
46. The carrier of statement 45, wherein the circuitry is further configured to, if there is an audio signal present at the tip or the ring of the first jack plug in response to the re-enabled microphone bias:
   confirm that the type of accessory is a stereo microphone.
47. The carrier of statement 42, wherein the circuitry is further configured to, if no audio signal is present at the tip or the ring of the first jack plug:
   enable a microphone bias to the tip and the ring of the first jack plug; and
   determine whether an audio signal is present at the tip or the ring of the first jack plug in response to the microphone bias; and, if there is an audio signal present in response to the microphone bias:
   disable the microphone bias applied to the ring of the first jack plug;
   determine whether audio input is present on the tip of the first jack plug; and, if there is audio input present on the tip of the first jack plug,
   determine that the type of accessory is a mono microphone connected to a 2-pole or to a 3-pole jack plug; and, if there is no audio input present on the tip of the first jack plug,
   determine that the type of accessory is a stereo microphone.
48. The carrier of statement 44, wherein the circuitry is further configured to:
   disable the microphone bias; and
   determine whether an audio signal is present at the tip or the ring of the first jack plug and, if there is an audio signal present:
   reclassify the type of accessory as a stereo line-in accessory.
49. The carrier of statement 44, wherein the circuitry is configured to:
   disable the microphone bias;
   determine whether playback is enabled on an accessory connected to the first jack plug;
   compare the output of one or more digital-to-analogue converters with the output of one or more analogue-to-digital converters;
   determine whether the digital-to-analogue converter output matches the analogue-to-digital converter output; and, if the outputs do not match,
   reclassify the type of accessory as a stereo line in accessory.
50. The carrier of any of statements 42-49, the circuitry being further configured to, if no audio signal is present at the tip or the ring of the first jack plug:
   enable an ultrasonic tone; and
   determine whether the ultrasonic signal is present at the tip or the ring of the first jack plug in response to the ultrasonic tone and, if the ultrasonic signal is present at the tip or the ring of the first jack plug;
   determine that the type of accessory is a stereo microphone.
51. The carrier of statement 50, wherein the circuitry is further configured to, if no ultrasonic signal is present at the tip or the ring of the first jack plug in response to the ultrasonic tone:
   determine that the type of accessory is a headphone and/or a line load.
52. The carrier of statement 50 or 51, wherein to enable the ultrasonic tone, the circuitry is configured to:
   cause the ultrasonic tone to be output from one or more speakers and/or causing a transducer to transmit the ultrasonic tone.
53. The carrier of statement 52, wherein the circuitry is further configured to:
   determine a delay between the ultrasonic tone being received via the electrical path from the transducer and/or or speaker that output the ultrasonic tone and via an acoustic path between the transducer and/or speaker that output the ultrasonic tone and a transducer receiving the ultrasonic tone.
54. The carrier of any of statements 42-53, wherein the circuitry further comprises:
   a first jack plug detect module configured to detect whether the first jack plug is received in the first jack port.
55. The carrier of any of statements 42-54, wherein the circuitry comprises a first circuitry module and a second circuitry module, the first circuitry module comprising at least one of:
   left audio out circuitry;
   right audio out circuitry;
   impedance measurement circuitry;
   microphone biasing circuitry;
   microphone and ground switching circuitry; and
   microphone input circuitry;
and wherein the second circuitry module comprises at least one of:
   a first stereo input circuitry;
   a second stereo input circuitry;
   impedance measurement circuitry;
   microphone biasing circuitry; and
   ground circuitry.
56. The carrier of any of statements 42-55, wherein the circuitry comprises at least one of:
   a first source of voltage bias;
   a first headset bias line connected to the bias and connectable to the sleeve of a 4-pole jack plug;
   a second headset bias line connected to the bias and connectable to the second ring of a 4-pole jack plug or to the sleeve of a 3-pole jack plug;
   a first stereo left line connected to the bias and connectable to the tip of a 3-pole or a 4-pole jack plug;
   a second stereo right line connected to the bias and connectable to the ring of a 3-pole jack plug or to the first ring of a 4-pole jack plug;
   a first digital to analogue converter;
   a first left headphone output line connected to the first digital to analogue converter and connectable to the tip of a 3-pole or a 4-pole jack plug;
   a second digital to analogue converter;
   a first right headphone output line connected to the second digital to analogue converter and connectable to the ring of a 3-pole jack plug or to the first ring of a 4-pole jack plug;
   a first analogue to digital converter
   a first headset line connected to the first analogue to digital converter and connectable to the sleeve of a 4-pole jack plug;
   a second headset line connected to the first analogue to digital converter and connectable to the second ring of a 4-pole jack plug or to the sleeve of a 3-pole jack plug;
   a first right stereo input line connected to the first analogue to digital converter and connectable to the ring of a 3-pole jack plug or to the first ring of a 4-pole jack plug;
   a first stereo input ground line connectable to the second ring of a 4-pole jack plug or to the sleeve of a 3-pole jack plug;
   a second analogue to digital converter;
   a first left stereo input line connected to the second analogue to digital converter and connectable to the tip of a 3-pole or 4-pole jack plug;
   a second stereo input ground line connected to the second analogue to digital converter and connectable to the second ring of a 4-pole jack plug or to the sleeve of a 3-pole jack plug; and
   a third digital to analogue converter configured to output an audio signal to a speaker.
57. The carrier according to any of statements 42-56, wherein the circuitry is further configured to detect a type of accessory connected to the second jack plug inserted into the second jack port, the integrated circuit being configured to:
   determine whether an audio signal is present at the tip or the ring of the second jack plug; and, if there is an audio signal present at the tip or the ring of the second jack plug,
   determine that the type of accessory is a stereo line-in accessory and that the second jack plug is a 3-pole jack plug.
58. The carrier of statement 57, wherein the circuitry is further configured to, if no audio signal is present at the tip or the ring of the second jack plug:
   enable a microphone bias to the tip and the ring of the second jack plug; and
   determine whether an audio signal is present at the tip or the ring of the second jack plug in response to the microphone bias; and, if there is an audio signal present in response to the microphone bias,
   determine that the type of accessory is a stereo microphone and that the second jack plug is a 3-pole jack plug.
59. The carrier of statement 58, wherein the circuitry is further configured to, if there is no audio signal present in response to the microphone bias:
   determining that the type of accessory is a headphone and/or a line load and that the second jack plug is a 3-pole jack plug.
60. The carrier of statement 58, wherein the circuitry is further configured to:
   disable the microphone bias; and to check whether the type of accessory is a stereo microphone, wherein, to perform the check, the circuitry is configured to:
   re-enable the subsequent microphone bias to the tip and the ring of the second jack plug;
   determining whether an audio signal is present at the tip or the ring of the second jack plug in response to the re-enabled microphone bias.
61. The carrier of statement 60, wherein the circuitry is further configured to, if there is an audio signal present at the tip or the ring of the second jack plug in response to the re-enabled microphone bias:
   confirm that the type of accessory is a stereo microphone.
62. The carrier of statement 57, wherein the circuitry is further configured to, if no audio signal is present at the tip or the ring of the second jack plug:
   enable a microphone bias to the tip and the ring of the second jack plug; and
   determine whether an audio signal is present at the tip or the ring of the second jack plug in response to the microphone bias; and, if there is an audio signal present in response to the microphone bias:
   disable the microphone bias applied to the ring of the second jack plug
   determine whether audio input is present on the tip of the second jack plug; and, if there is audio input present on the tip of the second jack plug,
   determine that the type of accessory is a mono microphone connected to a 2-pole or to a 3-pole jack plug; and, if there is no audio input present on the tip of the second jack plug,
   determine that the type of accessory is a stereo microphone.
63. The carrier of statement 59, wherein the circuitry is further configured to: disable the microphone bias; and
   determine whether an audio signal is present at the tip or the ring of the second jack plug and, if there is an audio signal present:
   reclassify the type of accessory as a stereo line-in accessory.
64. The carrier of any of statement 59, wherein the circuitry is configured to:
   disable the microphone bias;
   determine whether playback is enabled on an accessory connected to the second jack plug;
   compare the output of one or more digital-to-analogue converters with the output of one or more analogue-to-digital converters;
   determine whether the digital-to-analogue converter output matches the analogue-to-digital converter output; and, if the outputs do not match,
   reclassify the type of accessory as a stereo line in accessory.
65. The carrier of any of statements 57-64, the circuitry being further configured to, if no audio signal is present at the tip or the ring of the second jack plug:
   enable an ultrasonic tone; and
   determine whether the ultrasonic signal is present at the tip or the ring of the second jack plug in response to the ultrasonic tone and, if the ultrasonic signal is present at the tip or the ring of the second jack plug;
   determine that the type of accessory is a stereo microphone and that the second jack plug is a 3-pole jack plug.
66. The carrier of statement 65, wherein the circuitry is further configured to, if no ultrasonic signal is present at the tip or the ring of the second jack plug in response to the ultrasonic tone:
   determine that the type of accessory is a headphone and/or a line load.
67. The carrier of statement 65 or 66, wherein to enable the ultrasonic tone, the circuitry is configured to:
   cause the ultrasonic tone to be output from one or more speakers and/or causing a transducer to transmit the ultrasonic tone.
68. The carrier of statement 67, wherein the circuitry is further configured to:
   determine a delay between the ultrasonic tone being received via the electrical path from the transducer and/or or speaker that output the ultrasonic tone and via an acoustic path between the transducer and/or speaker that output the ultrasonic tone and a transducer receiving the ultrasonic tone.
69. The carrier of any of statements 57-68 further comprising:
   a second jack plug detect module configured to detect whether the second jack plug is received in the first jack port.
70. The carrier of any of statements 57-69, wherein the circuitry comprises a third circuitry module and a fourth circuitry module, the third circuitry module comprising at least one of:
   left audio out circuitry;
   right audio out circuitry;
   impedance measurement circuitry;
   microphone biasing circuitry;
   microphone and ground switching circuitry; and
   microphone input circuitry;
and the fourth circuitry module comprising at least one of:
   a first stereo input circuitry;
   a second stereo input circuitry;
   impedance measurement circuitry;
   microphone biasing circuitry; and
   ground circuitry.
71. The carrier of any of statements 57-70, wherein the circuitry further comprises at least one of:
   a third source of voltage bias;
   a third headset bias line connected to the bias and connectable to the sleeve of a 4-pole jack plug;
   a fourth headset bias line connected to the bias and connectable to the second ring of a 4-pole jack plug or to the sleeve of a 3-pole jack plug;
   a third stereo left line connected to the bias and connectable to the tip of a 3-pole or a 4-pole jack plug;
   a fourth stereo right line connected to the bias and connectable to the ring of a 3-pole jack plug or to the first ring of a 4-pole jack plug;
   a third digital to analogue converter;
   a third left headphone output line connected to the third digital to analogue converter and connectable to the tip of a 3-pole or a 4-pole jack plug;
   a fourth digital to analogue converter;
   a third right headphone output line connected to the fourth digital to analogue converter and connectable to the ring of a 3-pole jack plug or to the first ring of a 4-pole jack plug;
   a third analogue to digital converter
   a third headset line connected to the third analogue to digital converter and connectable to the sleeve of a 4-pole jack plug;
   a fourth headset line connected to the third analogue to digital converter and connectable to the second ring of a 4-pole jack plug or to the sleeve of a 3-pole jack plug;
   a third right stereo input line connected to the third analogue to digital converter and connectable to the ring of a 3-pole jack plug or to the first ring of a 4-pole jack plug;
   a third stereo input ground line connectable to the second ring of a 4-pole jack plug or to the sleeve of a 3-pole jack plug;
   a fourth analogue to digital converter;
   a third left stereo input line connected to the fourth analogue to digital converter and connectable to the tip of a 3-pole or 4-pole jack plug;
   a fourth stereo input ground line connected to the fourth analogue to digital converter and connectable to the second ring of a 4-pole jack plug or to the sleeve of a 3-pole jack plug; and
a fifth digital to analogue converter configured to output an audio signal to a speaker.
72. A device comprising the carrier of any of statements 34-71.

1. Circuitry for detecting a type of accessory connected to a first jack plug inserted into a first jack port, the circuitry being configured to:
determine whether an audio signal is present at the tip or the ring of the first jack plug; and, if there is an audio signal present at the tip or the ring of the first jack plug,
determine that the type of accessory is a stereo line-in accessory connected to a 3-pole jack plug.

2. Circuitry of claim 1, wherein the circuitry is further configured to, if no audio signal is present at the tip or the ring of the first jack plug:
enable a microphone bias to be applied to the tip and the ring of the first jack plug; and
determine whether an audio signal is present at the tip or the ring of the first jack plug in response to the microphone bias; and, if there is an audio signal present in response to the microphone bias,
determine that the type of accessory is a stereo microphone.

3. Circuitry of claim 2, wherein the circuitry is further configured to, if there is no audio signal present in response to the microphone bias:
determine that the type of accessory is a headphone and/or a line load.

4. Circuitry of claim 2, wherein the circuitry is further configured to:
disable the microphone bias; and to check whether the type of accessory is a stereo microphone, wherein, to perform the check, the circuitry is configured to:
re-enable the microphone bias to the tip and the ring of the first jack plug;
determining whether an audio signal is present at the tip or the ring of the first jack plug in response to the re-enabled microphone bias.

5. Circuitry of claim 4, wherein the circuitry is further configured to, if there is an audio signal present at the tip or the ring of the first jack plug in response to the re-enabled microphone bias:
confirm that the type of accessory is a stereo microphone.

6. Circuitry of claim 1, wherein the circuitry is further configured to, if no audio signal is present at the tip or the ring of the first jack plug:
enable a microphone bias to the tip and the ring of the first jack plug; and
determine whether an audio signal is present at the tip or the ring of the first jack plug in response to the microphone bias; and, if there is an audio signal present in response to the microphone bias:
disable the microphone bias applied to the ring of the first jack plug
determine whether audio input is present on the tip of the first jack plug; and, if there is audio input present on the tip of the first jack plug,
determine that the type of accessory is a mono microphone connected to a 2-pole or to a 3-pole jack plug; and, if there is no audio input present on the tip of the first jack plug,
determine that the type of accessory is a stereo microphone.

7. Circuitry of claim 3, wherein the circuitry is further configured to:
disable the microphone bias; and
determine whether an audio signal is present at the tip or the ring of the first jack plug and, if there is an audio signal present:
reclassify the type of accessory as a stereo line-in accessory.

8. Circuitry of claim 3 wherein the circuitry is configured to:
disable the microphone bias;
determine whether playback is enabled on an accessory connected to the first jack plug;
compare the output of one or more digital-to-analogue converters with the output of one or more analogue-to-digital converters;
determine whether the digital-to-analogue converter output matches the analogue-to-digital converter output; and, if the outputs do not match,
reclassify the type of accessory as a stereo line in accessory.

9. Circuitry of claim 1, the circuitry being further configured to, if no audio signal is present at the tip or the ring of the first jack plug:
enable an ultrasonic tone; and
determine whether the ultrasonic signal is present at the tip or the ring of the first jack plug in response to the ultrasonic tone; and, if the ultrasonic signal is present at the tip or the ring of the first jack plug,
determine that the type of accessory is a stereo microphone.

10. Circuitry of claim 9, wherein the circuitry is further configured to, if no ultrasonic signal is present at the tip or the ring of the first jack plug in response to the ultrasonic tone:
determine that the type of accessory is a headphone and/or a line load.

11. Circuitry of claim 9, wherein to enable the ultrasonic tone, the circuitry is configured to:
cause the ultrasonic tone to be output from one or more speakers and/or causing a transducer to transmit the ultrasonic tone.

12. Circuitry of claim 11, wherein the circuitry is further configured to:
determine a delay between the ultrasonic tone being received via the electrical path from the transducer and/or or speaker that output the ultrasonic tone and via an acoustic path between the transducer and/or speaker that output the ultrasonic tone and a transducer receiving the ultrasonic tone.

13. Circuitry of claim 1 further comprising:
a first jack plug detect module configured to detect whether the first jack plug is received in the first jack port.

14. Circuitry of claim 1 comprising a first circuitry module and a second circuitry module, wherein the first circuitry module comprises at least one of:
left audio out circuitry;
right audio out circuitry;
impedance measurement circuitry;
microphone biasing circuitry;
microphone and ground switching circuitry; and
microphone input circuitry;
and wherein the second circuitry module comprises at least one of:
a first stereo input circuitry;
a second stereo input circuitry;
impedance measurement circuitry;
microphone biasing circuitry; and
ground circuitry.

15. Circuitry of claim 1, wherein the circuitry further comprises at least one of:
a first source of voltage bias;
a first headset bias line connected to the bias and connectable to the sleeve of a 4-pole jack plug;
a second headset bias line connected to the bias and connectable to the second ring of a 4-pole jack plug or to the sleeve of a 3-pole jack plug;
a first stereo line for left audio input connected to the bias and connectable to the tip of a 3-pole or a 4-pole jack plug;
a second stereo line for right audio input connected to the bias and connectable to the ring of a 3-pole jack plug or to the first ring of a 4-pole jack plug;
a first digital to analogue converter;
a first headphone line for left headphone output connected to the first digital to analogue converter and connectable to the tip of a 3-pole or a 4-pole jack plug;
a second digital to analogue converter;
a second headphone line for right headphone output connected to the second digital to analogue converter and connectable to the ring of a 3-pole jack plug or to the first ring of a 4-pole jack plug;
a first analogue to digital converter;
a first headset line connected to the first analogue to digital converter and connectable to the sleeve of a 4-pole jack plug;
a second headset line connected to the first analogue to digital converter and connectable to the second ring of a 4-pole jack plug or to the sleeve of a 3-pole jack plug;
a first stereo input line for right stereo audio connected to the first analogue to digital converter and connectable to the ring of a 3-pole jack plug or to the first ring of a 4-pole jack plug; and
a first stereo input ground line connectable to the second ring of a 4-pole jack plug or to the sleeve of a 3-pole jack plug;
a second analogue to digital converter;
a second stereo input line for left stereo audio connected to the second analogue to digital converter and connectable to the tip of a 3-pole or 4-pole jack plug;
a second stereo input ground line connected to the second analogue to digital converter and connectable to the second ring of a 4-pole jack plug or to the sleeve of a 3-pole jack plug; and
a third digital to analogue converter configured to output an audio signal to a speaker.

16. A carrier comprising a first conductive path and a second conductive path, wherein the first conductive path is configured to electrically connect circuitry with a first jack port, and wherein the second conductive path is configured to electrically connect the circuitry with a second jack port.

17. The carrier of claim 16, wherein the circuitry comprises a first module configured to detect the insertion of a first audio jack in the first jack port and a second module configured to detect the insertion of a second jack plug in the second jack port, wherein the first conductive path is configured to electrically connect the first module with the first jack port, and wherein the second conductive path is configured to electrically connect the second module with the second jack port.

18. The carrier of claim 16 wherein the circuitry comprises tip detect circuitry and ring detect circuitry, wherein the first conductive path is configured to electrically connect the tip detect circuitry with the first jack port and wherein the second conductive path is configured to electrically connect the ring detect circuitry with the second jack port wherein the tip detect circuitry is configured to detect the insertion of the first audio jack plug in the first jack port and wherein the ring detect circuitry is configured to detect the insertion of the second audio jack plug in the second jack port.

19. The carrier of claim 16 wherein the circuitry comprises first tip detect circuitry and second tip detect circuitry, wherein the first conductive path is configured to electrically connect the first tip detect circuitry with the first jack port and wherein the second conductive path is configured to electrically connect the second tip detect circuitry with the second jack port, wherein the first tip detect circuitry is configured to detect the insertion of the first audio jack plug in the first jack port and wherein the second tip detect circuitry is configured to detect the insertion of the second audio jack plug in the second jack port.

20. The carrier of claim 16 comprising the first and second audio jack ports.
